(19) United States
(12) Patent Application Publication
(10) Pub. No.: US 2004/0196265 A1
(43) Pub. Date: Oct. 7, 2004

(54) System and method for finger held hardware device

(76) Inventor: Steven P. Nohr, Bothell, WA (US)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 10/484,069

(22) PCT Filed: Jul. 17, 2002
(86) PCT No.: PCT/US02/22851

Related U.S. Application Data
(60) Provisional application No. 60/305,615, filed on Jul. 17, 2001.

(51) Int. Cl. G09G 5/00

(52) U.S. Cl. 345/169

(57) ABSTRACT

A finger held hardware device provides portable terminal and communicative devices and other functions in a system which can be securely braced against and/or attached to a finger or side of a user's hand, facilitating secure or one-handed operation of the device. The device is flexible and modular in nature, allowing for flexible positioning of a keypad/control unit relative to a display, as well as selection from among various displays and keypad/control units to suit a user's needs. A device can operate without physical function buttons or any physical buttons, and can be activated by a separate key mechanism for security. A remote control stylus allows a user to operate the device more quickly. An energy absorbing cover protects the device. A resource cradle supports portions of the device by providing power, storage, network access, and other resources.

### CROSS-REFERENCE TO RELATED APPLICATION

This application claims priority from U.S. Provisional Application No. 60/305,615, filed Jul. 17, 2001.

### TECHNICAL FIELD

The present invention relates to personal electronic devices. More particularly, the present invention relates to systems and methods for physically supporting, controlling, customizing, accessing, and protecting personal electronics devices

### BACKGROUND OF THE INVENTION

Portable, personal electronics devices have become increasingly more popular as the costs to manufacture and sell them has decreased. Cellular telephones, handheld computers, portable game players, and other related devices have become commonplace. Furthermore, users have become increasingly dependent on these devices, using them more and more, and for an increasing range of applications. For example, people use cellular telephones seemingly constantly. Moreover, cell phone users use their cell phones to send text messages, browse the Internet, and for many other purposes. Similarly, handheld computer users not only have come to rely on these devices for keeping appointment calendars and address lists, but now use these devices for everything from casual word processing, to posting on-line transactions, to playing games

With the passage of time, the use of these devices has become better understood to the point of second nature. Users know which buttons perform which functions without great mental deliberation. In fact, it is not uncommon to see an individual conduct a phone call with her cellular phone in one hand, while operating her handheld computer with another.

Unfortunately, the creators of current devices seemingly designed them with an expectation that use of these devices would be more single-minded, and that a user would be willing to devote both hands to the task. As a result, while a user may not be intimidated by the prospect of using his cellular phone and his handheld computer at the same time, manipulating the controls on these devices might not be practical or possible. A typical cellular phone is much more easily dialed if the user cradles the phone in one hand and dials with the other. Use of a typical handheld computer also requires two hands: one is needed to support the handheld unit, while the other operates a stylus or presses keys to initiate various commands.

A similar concern is that while a handheld computer may be designed in a way in which it is well-suited for some applications, it may not be for others. For example, it may be a simple matter to access one's schedule for the day by depressing the calendar function button, then scrolling down through the day using scroll keys. This can be done with one hand while resting the handheld device on a table or desk, but is not easily done if one both tries to hold and control the device with one hand. Further, if one wants to use the handheld computer's calculator functions, because the stylus or another tapping device is required to actuate the touch-screen “buttons” of the calculator program, one cannot merely use the calculator with one hand while writing down the resulting figures with another.

Handheld devices also pose other concerns. To name one example, it is good to have a compact cellular phone so it can be carried easily; on the other hand, when viewing text, a larger display would be very helpful. Similarly, the ability to send text messages is very useful, but it would be more helpful if a more user friendly keyboard could be provided. Security is a concern when so many people store so much valuable information in various types of handheld devices. Comparably, so many people rely on their devices that if the device were damaged, the user may have suffered a tragedy. Finally, while compact devices are convenient, they often sacrifice expandability in exchange for small size; certainly, it would be helpful to be able to augment the function of these devices as needed.

Overall, what is needed is a way to make portable electronic devices more ergonomic so that even unskilled users can more easily operate them with a single hand, or can do more with the devices while using both hands. Devices need to be better secured and protected, and to allow for upgradeability and flexibility in function.

It is to these objects that the present application is directed.

### SUMMARY OF THE INVENTION

There are numerous general variations of the present invention.

One form of the present invention employs on a lower corner of the device a finger and thumb based support, attachment, and activation device. In this manner, a user can both support and operate the handheld device with one hand, leaving her other hand free for other tasks or, at least, reducing the demand on the hand supporting the device.

A variation of the present invention features detachable and interchangeable display and button-based mechanisms. In this way, users can attach different keypads for different applications or to suit a preference of which hand to use in operating the device. Similarly, users can attach different types of displays for different applications.

Another variation of the present invention has no physical buttons on which all commands are initiated via a touch-sensitive display. The only physical button on this variation is a power switch to activate the device.

Another variation of the present invention has no physical buttons on which all commands are initiated via a touch-sensitive display. Because there are no physical buttons, the device can only be accessed with a separate key to activate the device.

Another variation of the present invention receives input both conventionally from the pressing of function control buttons as well as pressing of touch sensitive areas on the touch screen, and from remote control signals issued by a user activating buttons on a remote control stylus.

Another variation of the present invention is largely covered with a gel pad to protect the device from damage that it might suffer upon being dropped or handled roughly, as well as to allow a user a better grip on the device.

Another variation of the present invention employs resource cradle for providing functional support to various sections of the device.

### BRIEF DESCRIPTION OF THE DRAWINGS

FIG. 1 is a front view of one embodiment employing on a lower corner of the device a finger activated keypad and a finger attachment means.

FIG. 2A is a front view another embodiment which features detachable and interchangeable display and keypad/control units.

FIG. 2B is a front view of the embodiment shown in FIG. 2A showing an alternative keypad/control unit that can attached to the display device.

FIG. 2C is a front view of the embodiment shown in FIG. 2B showing the alternative keypad/control unit attached to the display device.

FIG. 2D is a front view of the embodiment shown in FIG. 2A using a rotatable keypad/control unit.

FIG. 2E is a front view of the embodiment shown in FIG. 2A using a rotatable keypad/control unit oriented to allow a user to hold the device at a different angle.

FIG. 2F is a front view of the embodiment shown in FIG. 2A using an alternate function keypad/control unit.

FIG. 2G is a front view of the embodiment shown in FIG. 2A using a different display device.

FIG. 3 is a front view of another embodiment in which the handheld device accepts commands through the touch screen device with the exception of a power switch.

FIG. 4A is a front view of another embodiment in which the handheld device accepts commands only through the touch screen device, and can only be activated through the use of a key.

FIG. 4B is a front view of another embodiment in which the handheld device accepts commands only through the touch screen device, and can only be activated through the use of a wireless access device.

FIG. 5A is a front view of another embodiment in which a handheld device receives input both conventionally from the pressing of function control buttons and on the touch-sensitive screen, as well as from a remote control stylus.

FIG. 5B is a bottom view of the remote control stylus shown in FIG. 5A.

FIG. 6A is a front view of another embodiment in which a handheld device is covered by a protective gel pad.

FIG. 6B is an underside view of another embodiment in which a handheld device is covered by a protective gel pad.

FIG. 6C is an underside view of a variation of the embodiment in which a handheld device is covered by a protective gel pad.

FIG. 7A is a perspective view of another embodiment of a resource cradle used by the handheld device.

FIG. 7B is a perspective view of a resource cradle used by a different embodiment of the handheld device.

FIG. 7C is a perspective view of a resource cradle used by a keypad/control unit.

FIG. 7D is a perspective view of a resource cradle used by an alternate keypad/control unit.

FIG. 7E is a perspective view of a resource cradle used by a plurality of devices at the same time.

FIG. 8 is a general block diagram of a finger held hardware device employing one particular design of the preferred embodiment of the present invention;

FIG. 9 is a general block diagram of a finger held hardware device employing a remote control unit, network card, removable media, and wired capabilities.

FIG. 10 is an embodiment of the present invention employed in another type of finger held hardware device.

FIG. 11 is an embodiment of the present invention utilizing various forms of removable functions and capabilities of finger held hardware device;

FIG. 12 is a general block diagram of a finger held hardware device employing one particular design to remove multiple portions of a device.

FIG. 13 is a general block diagram of a finger held hardware device employing that enables any removable portions of a device.

FIG. 14 is an embodiment of the present invention employed utilizing a modified version of finger held hardware device.

FIG. 15 is an embodiment of the present invention employed utilizing a modified version of a viewable screen apparatus to provide a user with the same capabilities as an entire portable terminal device.

FIG. 16 is an embodiment of the present invention utilizing a modified version of a physical button apparatus to perform the same capabilities as an entire portable terminal device, as well as its interchangeability with at last one type of portable terminal device, and/or a viewable screen device, and/or a finger held hardware device, or any other type of portable device.

FIG. 17 is a general block diagram of at least one type of gel pad.

FIG. 18 is an embodiment of the present invention employed utilizing a modified version of a viewable screen apparatus, finger held hardware device, and/or any type of portable device that does not have any physical buttons or characteristics;

FIG. 19 is an embodiment of the present invention employed utilizing possible modified versions or variations of a viewable screen apparatus, finger held hardware device, and/or any type of portable device that does not have any physical buttons.

FIG. 20 is an another embodiment of the present invention employed utilizing possible modified versions of variations of a viewable screen apparatus, finger held hardware device, and/or any type of portable device that does not have any physical buttons.

FIG. 21 is a general block diagram of a stand device employing one particular design that supplies function to any type or component of finger held device.

FIG. 22 is a general block diagram of a stand device employing one particular design that provides various types and forms of interaction.

FIG. 23 is an embodiment of the present invention utilizing a modified version of finger held hardware device that employs modified versions of a viewable screen apparatus enabling the a viewable screen apparatus to be moved by the user.

FIG. 24 is an embodiment of the present invention utilizing a modified version of finger held hardware device that employs modified versions of a viewable screen apparatus enabling the a viewable screen apparatus to be moved.

FIG. 25 is a general block diagram of a cellular phone based finger held hardware device employing one particular design that enables any type of finger held device, with a fixed and/or removable display screen device and physical button device that can provide various functions.

FIG. 26 is an embodiment of the present invention employed utilizing a modified version of finger held hardware device that employs modified versions of a cellular phone based finger held hardware device.

### DETAILED DESCRIPTION OF THE INVENTION

Embodiments of the present invention are directed to providing handheld electronic devices, such as personal digital assistants, cellular phones, game players, digital cameras, and media players, with functional advantages. These advantages include improved ways of holding the devices, improved flexibility in function of these devices, and improved security, among other objectives. One skilled in the art will understand, however, that the present invention may be practiced without several of the details described in the following description. Moreover, in the description that follows, it is understood that the figures related to the various embodiments are not to be interpreted as conveying any specific or relative physical dimensions, and that specific or relative physical dimensions, if stated, are not to be considered limiting unless the claims expressly state otherwise. Further, illustrations of the various embodiments when presented by way of illustrative examples are intended only to further illustrate certain details of the various embodiments, and shall not be interpreted as limiting the scope of the invention.

There are several general embodiments of the invention, which will be described first, as well as several more detailed embodiments of the invention.

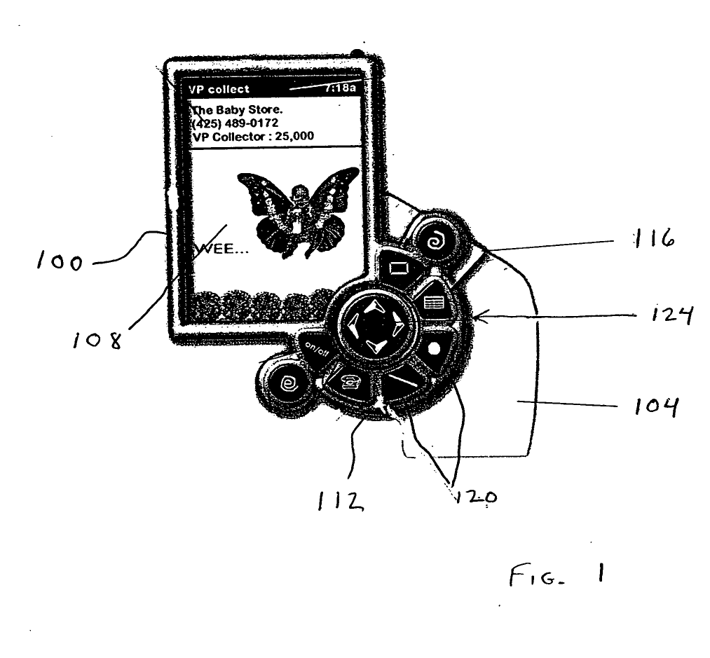

A first general embodiment of the present invention is a finger held personal electronics device. FIG. 1 shows a top view of a finger held device 100 supported by a user's hand 104. The finger held device generally comprises three sections: a display 108, a control unit 112, and an attachment device 116. The display device 108 provides data viewing access and/or touch screen control as is generally known with handheld computers. However, as compared with conventional handheld computers which have control buttons disposed across the bottom edge of the device under the lower portion of the display, in the embodiment shown, the control buttons 120 are arrayed on a keypad 124 on the control unit 112 which can be positioned over a user's hand 104.

Positioning the keypad 124 on the control unit 112 in this way shifts some of the weight of the finger held device 100 over the top of the user's hand 104 to better allow the finger held device to be supported by one hand, as compared to a conventional handheld device wherein the center of gravity would be positioned further away from the user's hand. In addition, by moving the keypad 124 over the user's hand 104, pressure applied to the keypad 124 is directed through the keypad 124 and against the user's hand 104. Accordingly, depressing the keys 120 only helps to secure the finger held device 100 against the user's hand 104, rather than twist the device out of a user's hand as might happen if a user attempted to support a conventional device in this manner and depressed keys which are positioned away from the user's hand 104.

In addition, for extra security and support in allowing the user to hold the device with one hand, a finger attachment device 116 allows the user to secure the device 100 about one or more fingers of the user's hand 104. The finger attachment device 116 can be a flexible strap the user can wrap around one or more of the fingers of his hand 104. Alternatively, the finger attachment device 116 can be a more rigid ring type device into which the user can slip one or more of the fingers of the user's hand 104. With the device 100 anchored to the user's hand 104 by this finger attachment device, the user need not concern himself with making sure he is hanging onto the device 100 so as to fully support its weight and the force of any force applied in operating the device 100. The finger attachment device 116 ensures the device will not fall.

With the keypad 124 moved over the off-centered control unit 112 and secured to the user's hand 104 with the finger attachment 116 mechanism, the user can actuate keys 120 on the keypad 124 with the thumb of the user's hand 104 without dropping the device. Even if the user chooses to use his other hand to actuate the device, the user need not concentrate on directing the muscle's of his own hand 104 to support the device at that time because the application of force on an axis through the user's hand 104 coupled with the finger attachment device 116 make it much easier to support the device 100.

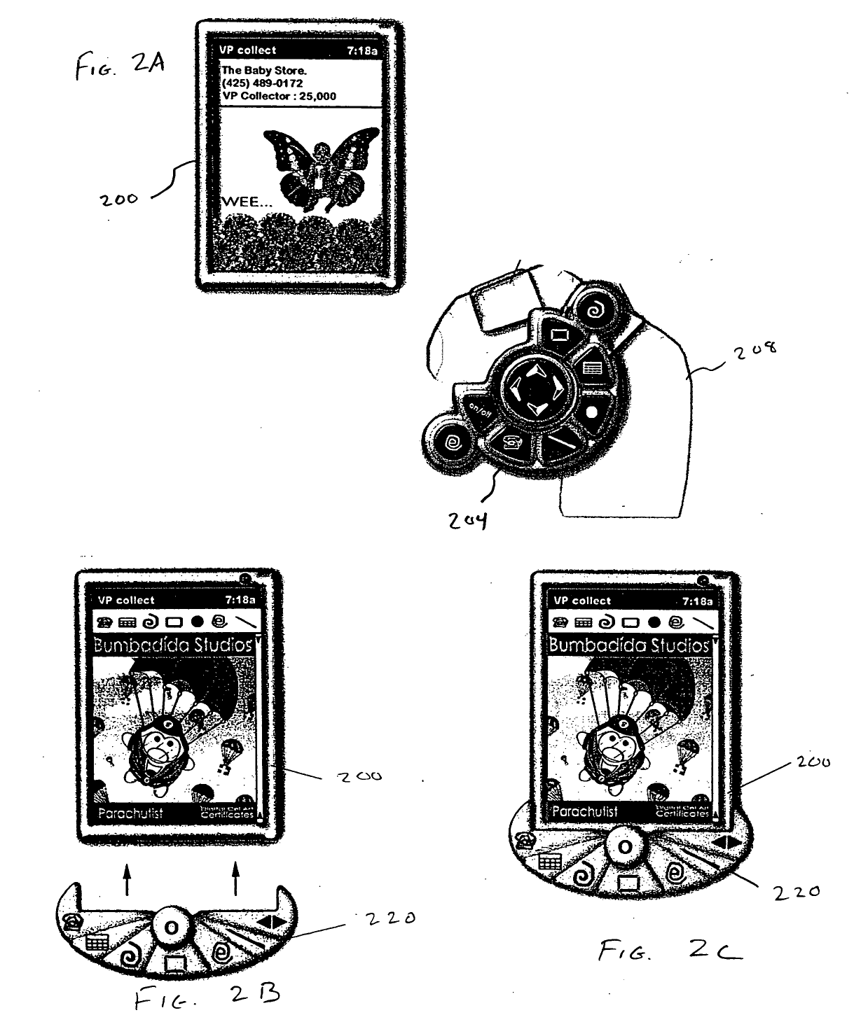

Another general embodiment of the present invention shown in FIG. 2A features detachable and interchangeable display 200 and keypad/control units 204. In this way, users can attach different keypad/control units 204 for different applications or to suit a preference of which hand 208 to use in operating the device. Similarly, users can attach different displays 200 for different applications. Parts of the device can be exchanged with others to be able to exchange data with other users of such a system.

In a preferred version of this embodiment, both the displays 200 and the keyboard/control units 204 have resident logic systems and power supplies (not shown). Accordingly, one type of keypad/control unit 204 might have resident functions or store downloadable applications, while another might have different resident functions and store different applications. The keypad/control units 204 might be of the same form, just having different functions and applications, and their interchangeability might be comparable to changing a cartridge in a handheld game system. It will be appreciated that the keypad/control units 204 can be adapted to receive such cartridges, whether they store applications, data, media files, or other helpful content in any of the embodiments disclosed in this specification.

Alternatively, as shown in FIGS. 2B and 2C, alternative keypad/control units 220 can be of different shapes, have keys related to different functions, or have different keypad arrangements entirely. FIG. 2B shows a more linear keypad/control unit 220 to be coupled with the display as shown in FIG. 2C. Moreover, keypad/control units 204, in the detachable embodiment or the previously described embodiment, can comprise rotatable keypads 124 (FIG. 1). These rotatable keypads 124 allow a user to arrange the keys to suit her preferences. Similarly, the rotatable aspect of the keypad/control units 204 (FIG. 2A) can allow the user to position the display 200 at different angles to the keypad/control unit 204. As shown in FIG. 2A, one user might select a position where the keypad/control unit 204 is positioned more to one side of the display 200. On the other hand, as shown in FIG. 2D, another user might choose to position the keypad/control unit 204 more directly beneath the display 200, or as shown in FIG. 2E, the user might prefer to position the display 200 to the opposite side of the keypad/control unit 204. Further, considering the relative position of the display 200 and the keypad/control unit 204, this rotation would allow for a user to adjust the device to use it on his opposite hand.

In addition, alternative keypad/control units can have keypad arrangements targeted toward different applications. For example, if a cellular telephone is incorporated in the keypad/control unit as shown in FIG. 2F, the telephone keypad control/unit 230 could have a conventional telephone keypad arrangement. A keypad/control unit for special math functions (not shown) could have calculator keys for calculation intensive applications, while another could have more typical scrolling and clicking keys. If a gaming system is incorporated in the keypad/control unit (not shown), the keys could be tailored to a specific game, or the keypad arrangement could mirror a keypad layout of a popular game controller.

Just as the keypad control units can be of different types, displays can be of different types as shown in FIG. 2G. A typical handheld computer display of a few inches on a side as shown in FIGS. 2A through 2F might be suitable for most typical handheld computer applications or for a gaming system. A larger display (not shown) might be chosen if the device is being used for reading e-books or e-magazines. Alternatively, if the device is being used primarily as a telephone directory and/or cellular phone/paging device, a compact display 240, which might comprise even a single-line display, might be chosen for the space and weight savings in the smaller package.

In this detachable embodiment, both the display and the keypad control unit can have their own control logic, power supplies, and applications. As a result, a display used by itself can still have some resident functions which can be initiated through the touch-sensitive display. These displays, for example, may have some native functions such as calendaring and a to-do list manager. At the same time, a keypad/control unit might be added that includes a cellular telephone module and an address book function, therefore, combining these devices not only adds a device for entering commands to the display, but also adds additional functionality.

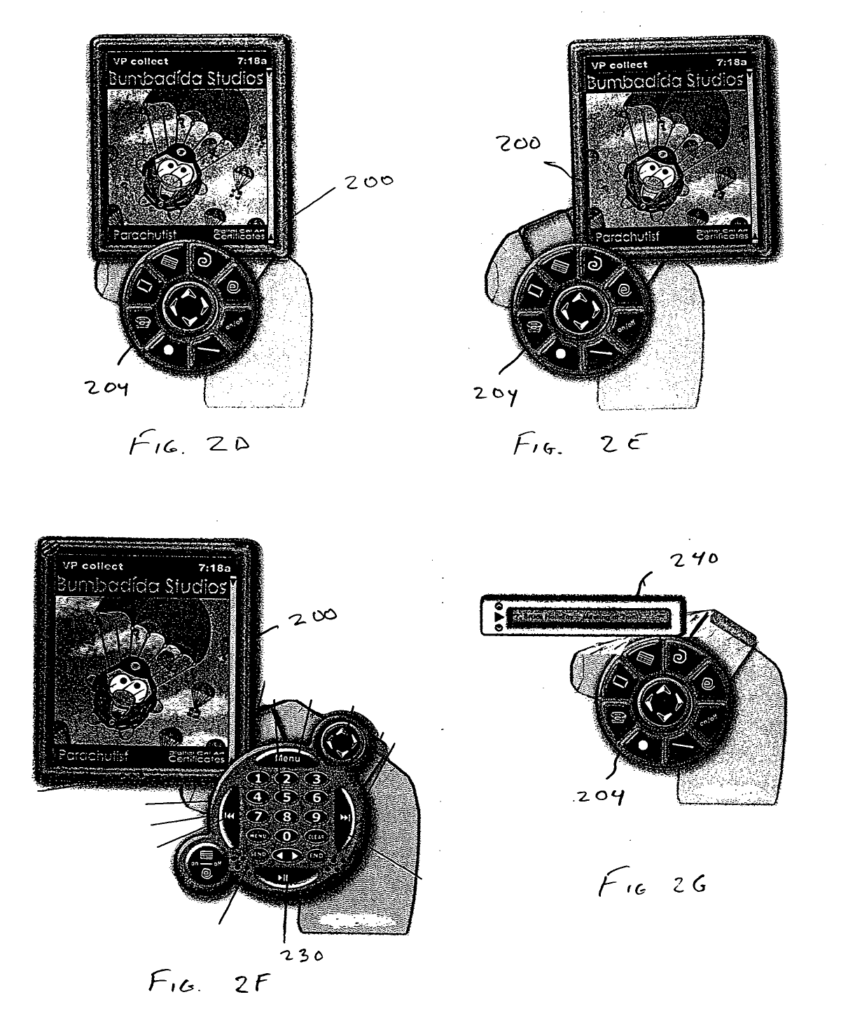

Along the lines of the detachable display with its own on-board functionality, another embodiment of the present invention shown in FIG. 3 is a handheld “display-only” device 300 with no physical buttons other than a power switch 304 to activate the turn the device on and off. The designation “display-only” is somewhat of a misnomer because, as previously described, the display would have its own power supply and control logic. Moreover, the display-only device 300 can be controlled through touch-screen directives through designated icons 308 on the viewing area 312 of the device. Variations of this embodiment could be coupled with a keypad/control unit as previously described to add different functions and user handling options. Notwithstanding, the display-only device can be a standalone device, or at least be able to function as a standalone device.

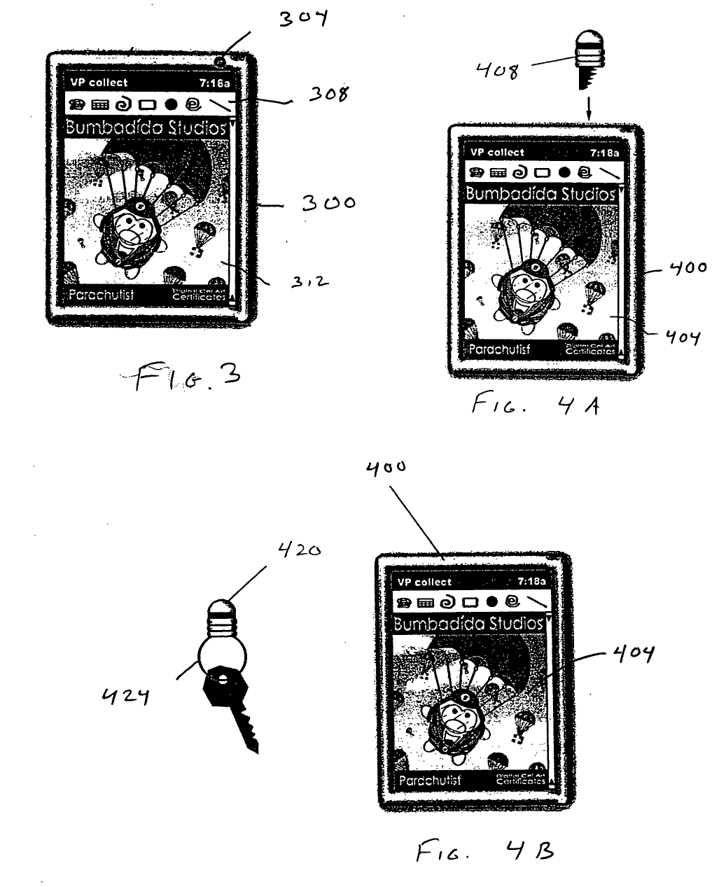

Another general embodiment of the present invention shown in FIGS. 4A and 4B is a handheld device 400 with no physical buttons with which all commands are initiated via a touch-sensitive display 404. In a preferred variation of this embodiment, although some predefined keystroke on the touch-sensitive display 404 could activate that the device 400, it may be preferred to require the user to carry a security key 408. By issuing a physical key 408 to a user, the user can be sure that the information in the unit is secure as long as the user keeps the key 408.

It will be appreciated that the key 408 can be a physical interlocking teeth type key, as shown in FIG. 4A, or other types can be used. FIG. 4B, for example, shows an radio frequency identification (RFID) tag 420. With an RFID tag, which the user could wear as a charm on a chain, carry in a pocket, or hang on a key ring 424 as shown, the user need not actually insert a key into the device 400. The device 400 would poll for the presence of the RFID tag 420, and when the RFID tag 420 is in suitable proximity to the device 400, the device 400 powers itself on. Again, if the device 400 is separated from the user, the user's information remains secure as long as he still has the RFID tag 420 with him. It will be appreciated that this same sort of security can be implemented without an interlocking key using infrared, bar code scanning, or similar technologies.

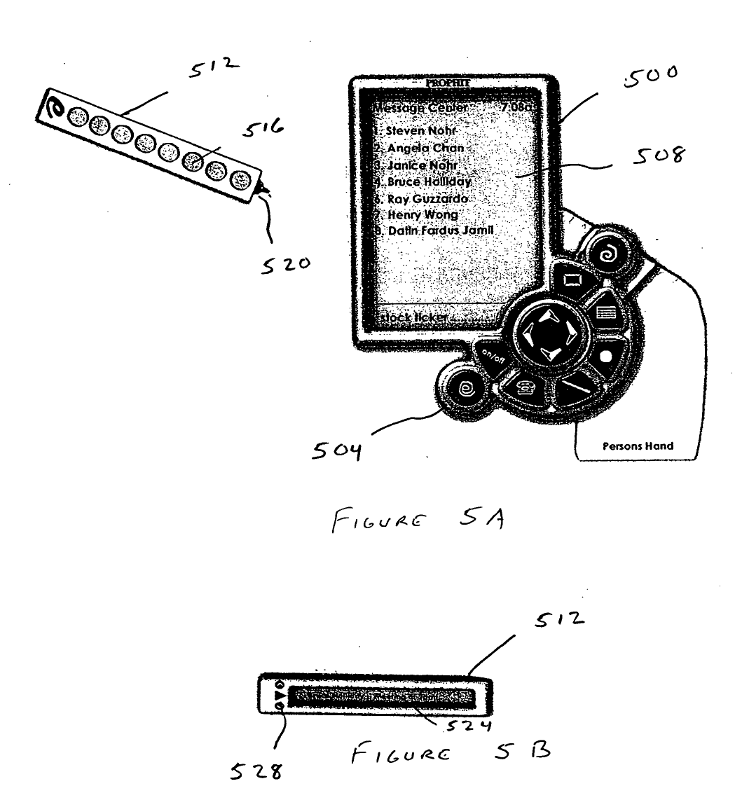

Another general variation of the present invention shown in FIGS. 5A and 5B is a handheld device 500 which receives input both conventionally from the pressing of function control buttons on the keypad/control unit 504, through entry of commands on the touch sensitive display 508, and from a remote control stylus 512. Using the remote control stylus 512, the user can enter commands by pressing function control buttons 516 which can be received by the device 500 via infrared, RF, ultrasonic signals, or similar transmission means. The remote control stylus 512 has a stylus tip, therefore a user need not carry multiple styli. Allowing the user to enter commands via remote control stylus 512 can speed system operation in a number of ways. For one, the function control buttons 516 on the remote control stylus 512 can bear keys which trigger functions different from those on the keypad/control unit 504, giving the user more one-touch commands to use. Similarly, the function control buttons 516 could initiate macros for generating text or triggering commands the user regularly uses. Further, because the user necessarily already uses a stylus to use the touch-sensitive display 508, without moving her hands, the user has access to more one-touch commands by merely pressing down with her fingers on a device she already holds in her hand.

FIG. 5B shows a reverse view of a variation of the remote control stylus 512. On a side away from the function control buttons 516, the remote control stylus 512 could support a display 524 which can display its own content, comparable to another window in a multitasking environment. For example, while a user browses notes on the display 508 (FIG. 5A) of the device 5, on the display 528 (FIG. 5B) of the stylus, the user could be reminded of impending appointments. The display 528 would display content transmitted by the device 500 (FIG. 5A) because, if the remote control stylus 512 can transmit to the device 500, using the same technology, the device 500 can transmit to the remote control stylus 512. It will be appreciated that the remote control stylus 512 and the device 500 can communicate using infrared, ultrasonic, RF, or similar technology. In fact, the same functions could be provided by a remote control stylus 512 coupled to the device 500 by a wired interface (not shown).

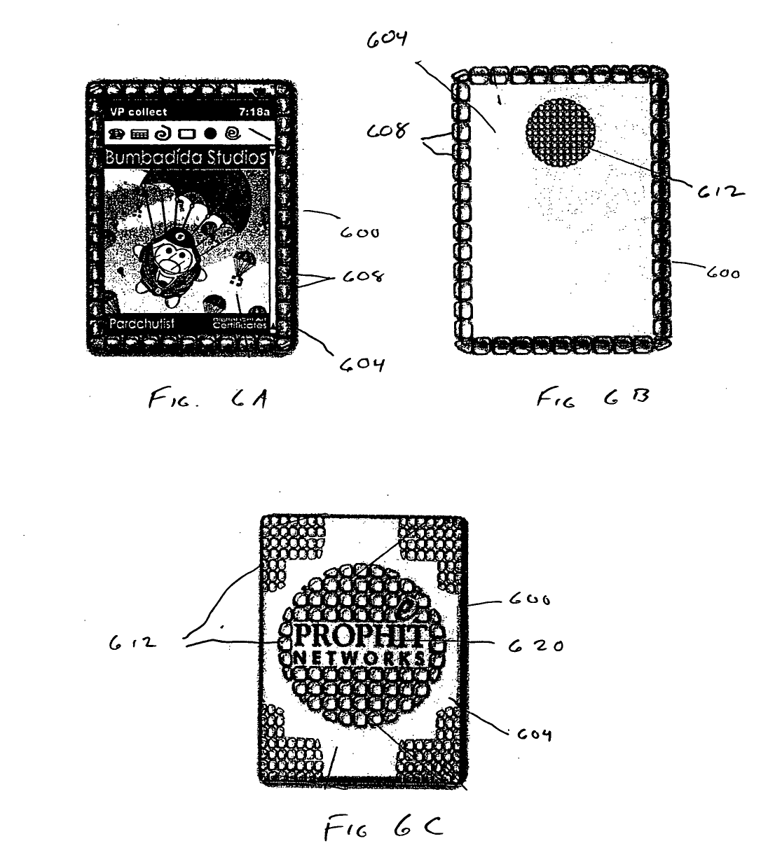

Another general embodiment of the present invention shown in FIGS. 6A, 6B, and 6C is a handheld device 600 protected by a gel pad 604. The gel pad 604 is comprised of the energy-absorbing gel type material which has become popular for shoe insoles. As shown in FIG. 6A, the gel pad 604 can provide ridges 608 of thickened pockets of gel to help absorb blows to the device 600 if the device 600 should be dropped or otherwise experience shock. FIG. 6B shows a rear view of the gel pad 604 installed on the device 600. FIG. 6A shows how the ridges 608 extend around the perimeter of the device 600 to protect it. Moreover, it will be appreciated that these ridges 608, as well as one or more textured pads 612, can make the gel pad 604 more tacky. Increasing the tackiness of the device 600 allows a user to more securely hold the device 600. Further, if an underside of the device 600 is tacky, the device 600 is less likely to slide off of a surface on which it has been rested, further protecting the device from potential harm. FIG. 6C shows another variation of the underside of the gel pad 604 showing that the textured pad 612 can be created in the form of a logo or another message. Thus, the gel pad 604 can carry the logo of the manufacturer of the device 600, or the gel pad 604 may carry personalized or personalizable content in the same way that such content is available on hard shell covers for cellular telephones. It should be noted that the content on hard shell cellular phone covers adds no tackiness to the case of the cellular phone, nor does it serve to protect the phone.

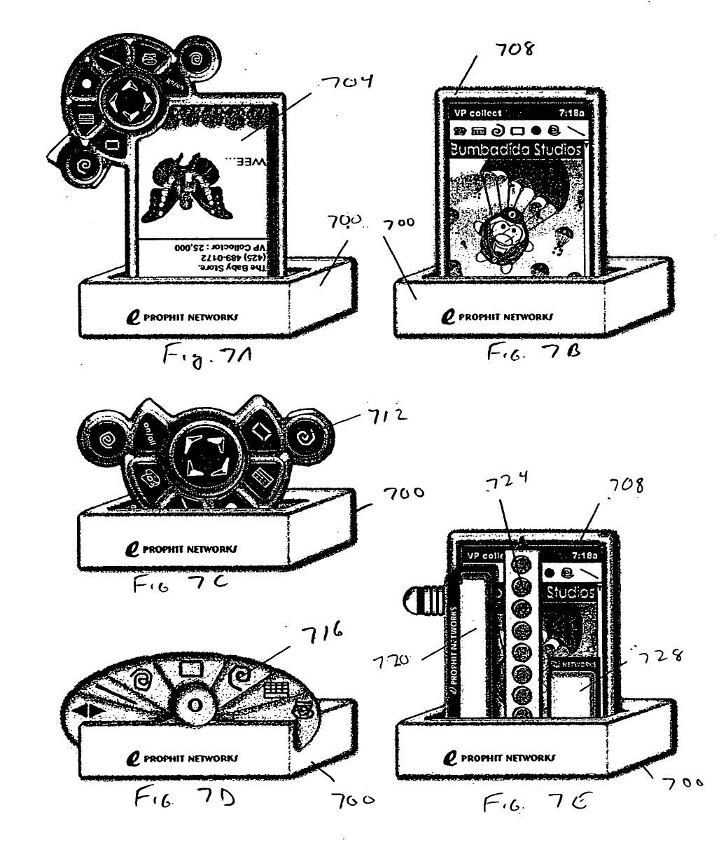

FIGS. 7A, 7B, 7C, 7D, and 7E show one more aspect of the present invention, a resource cradle 700 for the devices previously described. Considering the flexible aspect of the handheld devices previously described, the resource cradle 700 needs to be able to accommodate a wide range of devices and configurations. FIG. 7A shows a unified handheld device 704 coupled with the resource cradle 700. FIG. 7B shows a display-only handheld device 708 as previously described coupled with the resource cradle 700. FIGS. 7C and 7D show a keypad/control unit 712 and an alternate keypad/control unit 716, respectively, coupled with the resource cradle 700. FIG. 7E sho2s a display-only device 708, a wireless transmission module 720, a remote control stylus 724, and an auxiliary function module 728 all coupled with the resource cradle. It will be appreciated that one resource cradle can provide multiple couplings to accommodate various devices in use in the system previously described.

The resource cradle 700 provides a variety of functions to the devices it serves. Certainly, power supplies of the devices can be recharged by the cradle 700, just as the cradle 700 can be a conduit to another computer to synchronize the device with that other computer. In addition to these expected functions, however, the resource cradle 700 also provides additional functions to the devices with which it is coupled. The resource cradle 700 can provide function to the devices without using a personal computer. The resource cradle 700 can provide a storage device (not shown) for backing up content stored on the handheld device, or for storing interchangeable content that a user can request be offloaded from the handheld device to storage, or downloaded from storage to the handheld device. As previously discussed, in the case of handheld devices with detachable display and keypad/control units, those devices have their own control logic, thus each can operate with a resource cradle 700 to exchange content. In addition, the resource cradle 700 can provide a network interface, a microphone and/or speakers for audio or telephony applications.

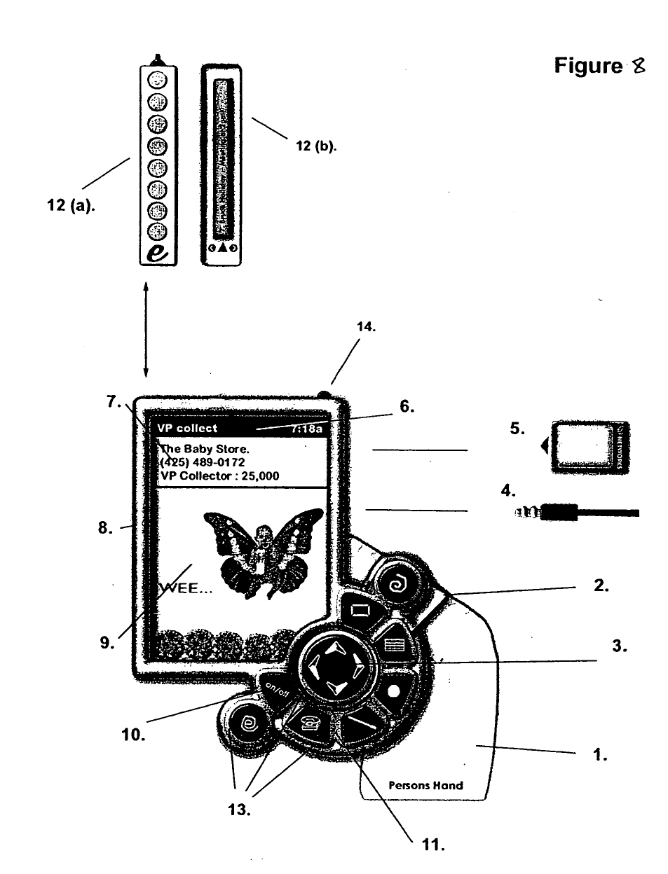

Turning to the more specific depictions of embodiments of the invention, FIG. 8 is a front side view of a finger held hardware device(s) 8 constructed in accordance with the invention. At least one type of finger held hardware device 8 can be designed, configured, manufactured, and sold to be utilized in providing, inputting, sending, receiving, interacting, storing all types of content, communications with any and all content, data, and information from internal means and methods, and/or from external means, and/or methods. Services can include at least one type of carrier, and/or network provider to/by/from at least one type of finger held hardware device(s) 8 with any and all content that is provided from the network(s) provider(s).

At least one type of finger held hardware device 8 can interact, receive, save, store, erase, exchange, or trade all types of content. At least one type of finger held hardware device 8 can turn ON/OFF 10 by physical means, at anytime, and/or can also be facilitated by various other means which do not require, and/or utilize at least one type of physical interface. At least one type of finger held hardware device 8 has the capability to turn ON/OFF 10 by itself, from off, sleep mode, wake mode when the user(s) receives any types of content, picks up at least one type of finger held hardware device 8, and/or becomes available based on ones location. At least one type of finger held hardware device 8 has the ability to turn OFF by itself, such as to save power resources or other purposes, and/or if the user does not engage any new content after a predetermined period of time, that is established by the user within the User Preferences of at least one type of finger held hardware device 8, and/or by setting up User Preferences from/by at least one type of carrier, and/or network provider, and/or user at the device level (hardware, software, middleware), and/or network level by many methodologies, protocols, platforms, configurations, and alike. At least one type of finger held hardware device 8 can also be designed and configured to automatically turn ON when a user connects, attaches, or come in contact with the device; such as slipping a portion of the finger held hardware device 8, such as a strap(s) 2 on to the users finger, thumb or other methodologies that determine the users presence or desire to turn ON the hardware device. The same can hold true when a user wishes to turn OFF their hardware device, by removing a finger, thumb or other methodologies that determines the users desire to turn OFF the hardware device.

At least one User can establish in the User Preferences of at least one type of finger held hardware device 8 what type(s) of content that the user wishes to receive/block out, allowing content in pre-identified categories to be sent to/from at least one type of finger held hardware device 8, as well as blocking any and all other types of content that the user does not wish to receive, or be informed about. At least one User can save, store, view, exchange, recall, trade, delete and alike all types of content from/to/with at least one type of finger held hardware device 8 internally, externally, removable media, and/or from/at/to at least one type of local and/or remote network. At least one type of content can be saved locally inside and/or outside of at least one type of finger held hardware device 8, and/or remotely that has been provided by at least one type of carrier, and/or network provider. If the user selected to save at least one type of content locally, the content could be saved internally, externally, and/or be saved onto at least one type of removable media or storage means 5. At least one type of antenna could be built into/out of the side frame of at least one type of finger held hardware device 8 on the 7, 8, and 9 number area, or other areas as determined by a manufacturer, distributor, dealer, carrier, provider, and/or user. At least one purpose for the antenna is to improve the signal strength, and coverage area to reduce to the furthest extent hot spots, dropouts, signal coverage stability, and/or disconnections while at least one user is operating at least one type of finger held hardware device 8.

At least one type of internal/external antenna can have the ability/capability in the hardware design, and/or software, and/or as provided by a middleware architecture to provide and/or enable at least one user, carrier, provider or alike to control the signal variation strength for/form/to at least one finger held hardware device 8 based on signal strength variations, whereby at least one finger held hardware device 8 can automatically, and/or manually be adjustable to enhance signal strength at times when signal strength is not at an optimum level, and/or at times when signal strength easily attained at an optimum level. In such cases, power resources, software applications, system architecture protocol, frequency variations and/or fluctuations can be utilized to maintain optimum operating environment, and can save power resources, maintain primary frequency utilization, and/or a multitude of other variations for achieving one in the same.

At least one type of finger held hardware device 8 may have the ability and expandability for at least one user to facilitate its interaction requests with At least one type of finger held hardware device 8 from at least one type of remote control device 12. At least one type of remote control device 12 can have at least one type of button, viewable screen, and the ability to be incorporated into any type of finger held hardware device 8 and have the ability to become detached. A front view 12 (a) for at least one type of remote control device 12 could be designed as illustrated, as well as the back view 12 (b) for at least one type of remote control device 12. At least one type of remote control device 12 can be designed to operate directly with at least one type of finger held hardware device 8, and/or any other type of hardware device(s), including but not limited to any type of data, information and networking communications from paging, cellular phone, wireless phone, computer devices, and/or desktop devices to name a few.

Interaction by/with/thru at least one type of remote control device 12 can provide the same or different capabilities as a manufacturer, carrier, provider, or user selects from at least one type of physical button(s) 3, 10, & 11 and can include basic navigation, to more complex functions, along with interacting with user preference settings, selection and decision of saving, deleting, recalling, viewing, exchanging, trading, any pre-stored content, stopping transmission of any type of content, selection of other categories, dialing phone numbers, sending and receiving email, text messaging services, stock ticker information, and other professional services, and/or subcategories including but not limited to phone, calendar, VP Collect, VP Gallery, email or message center, keyboard, scrolling, software categories, general section, plug-in, expansion slot, duel or split spectrum capabilities, and features.

At least one type of finger held hardware device 8 can enable at least one user with at least one type of viewable screen area 6, 7, and 9 area to review, interact, and/or interface with any and all types of virtual content. The upper part of the viewable screen area 7 may be utilized to either be a single screen design, duel screen, and/or split screen, that allows at least one type of content can be provided to the viewable screen area 9 portion, (in this example audio/visual content), while other types of content can be provided to the viewable screen area 7 portion, (in this example text based data and information) content. By utilizing more than one viewable screen area 6, 7, and 9 for at least one purpose, at least one type of user can actively be doing one thing (in say viewable screen area 9), while data, content, information, text messaging, email and other forms of interaction can be active (say on viewable screen area 7). In this way, at least one user is able to multi-task and is able to get more things done. At least one type of finger held hardware device 8 can also provide unlimited number of other types of content, entertainment, and information such as; playing electronic games of all types, styles, and formats, digital content, music, camera, video, professional services, information content, location means, network access means, and all types of content and services that can be provided to a user(s). These different types of content can either be connected and related, and/or separate in purpose than the other. At least one type of content can be configured and/or provided as continued information, and/or from time to time in portions, pieces, segments, and alike.

At least one type of speaker and microphone can be incorporated and/or provided on any portion of a finger held hardware device 8 principally to provide sound capabilities, but can also include voice recognition capabilities thru a speaker/microphone/video camera or other. At least one type of LED and/or lighting up of at least one type of button images 3, 10, and 11 assist the user at night and dark lit locations, including at least one portion of the viewable screen area 6, 7, and 9. At least one type of LED feature could be utilized to inform the user of current power resource levels, incoming/outgoing signal strength level, an incoming call, an incoming text message, a certain time reminder event based on a software application scheduler that utilizes time as part of, or in addition to a scheduler, how long another party has been on hold on another line, as well as if the finger held hardware device 8 is ON, in sleep mode, or OFF, whether the network card device, smart card device, headphone jack and/or wired data connection capabilities 4 and/or removable media 5 is properly or improperly connected, and/or ON/OFF, whether functioning properly, and much more.

At least one type of finger held hardware device 8 can come with gel pad capabilities 13. At least one type of gel pad 13 could be located anywhere on at least one type of device, and could be utilized for unlimited purposes. At least one type of gel pad 13 design, configuration, or alike can come as part of at least one type of device, hardware device, accessory device, media device, or all other types of physical objects. At least one type of gel pad 13 can be incorporated as part of, in addition to, or other at the factory level, as an aftermarket piece from a third party provider, wholesaler, distributor, dealer, distribution organization, as a consumer any type of object. Some examples of functions and features can include; at least one type of material that can make it easier for at least one type of user to utilize and interact with a device, to reduce physical user interaction from slipping around, to protect at least one type of device from the elements, weather, use, the impact and shock from dropping at least one type of device, for holding, connecting, engaging one device and/or portion of at least one type of device with another type of device, including accessories, upgrades, and the like.

At least one type of microphone 14 can equally be incorporated, or in addition to at least one type of finger held hardware device 8 design. At least one type of finger held hardware device 8 can be converted and/or utilized for a multitude of other purposes including; a digital camera, video camera, wireless phone, cellular phone, text messaging, a pager, walki-talkie, trunk radio, PDA, music player, game player, CD player, DVD player, desktop computer, laptop computer, notepad device, as well as a host of other types of hardware device capabilities. At least one type of finger held hardware device 8 can have at least one type of headphone jack and/or wired data connection capabilities 4 on the side for users to use headphone capabilities, wired and/or wireless data transfer to name a few.

At least one type of volume control can be provided on the outside/inside of at least one type of finger held hardware device 8 and/or accessory device such as a network card, remote control unit, or other type of device that would allow at least one user to utilize such features locally, and/or remotely, and/or can be provided to a user as part of, or in addition to at least one type of network card, smart card, remote control device 12, and/or removable media item.

At least one type of remote control device 12 can be designed at the factory level to perform at least one function, and/or be of any number of buttons, any size, any style, any design, any form, any format, any color, any shape, any material, and/or a plethora of variations that has any type of image, name, or reference on any such remote control device 12. At least one type of carrier, provider, device, and/or user can configure any numerable variations for at least one button. At least one type of strap(s) 2 can be part of, and/or in addition to at least one type of finger held hardware device 8 design enabling at least one type of user to have at least one means for holding, connecting, or being engaged with at least one type of finger held hardware device 8. At least one type of configuration for at least one button, but in particular for the design utilized in FIG. 8, the middle buttons 3 can be utilized to provide at least one user with up, down, left, and right scrolling, navigation, directory, sub-directory, and other command sets that the manufacturer, distributor, dealer, retailer, carrier, and/or provider user chooses/configures for these buttons from at least one type of hardware, software and/or middleware interface. At least one type of configuration for the middle buttons 3 can enable at least one user to play any type of game, and/or communication on the finger held hardware device 8.

At least one type of physical ON/OFF button 10 can be designed and utilized to override a sleep mode configuration, as well as a wake mode configuration that may come as standard, or is offered as a feature by at least one type of network provider or carrier, or established by at least one type of user and can be established as a default setting in the finger held hardware device 8. If at least one type of user wishes, they may actively change settings, and/or override the defaulted features at any time.

If/when at least one type of finger held hardware device 8 is in sleep mode, a finger held hardware device 8 can automatically wake up by itself by unlimited means, including but not limited to various types of content and/or data and information triggering (actively, and passively) be provided to the user—waking up the finger held hardware device 8 to allow the user to interact with the related content. If after a certain period of time, the user has not interacted with the finger held hardware device 8, and/or no new forms of communication, and/or content is not being provided to the finger held hardware device 8, the finger held hardware device 8 can automatically go into sleep mode to conserver power resources. At least one type of manufacturer, distributor, dealer, carrier, provider, and/or user can configure the finger held hardware device 8 so that when both sleep mode, and wake mode are commenced, the finger held hardware device 8 can provide the user with at least one type of [audio], [visual], [motion or vibration], or other means. There are multiple ways, means, and methods for at least one type of user to hold/attach/connect 2 the finger held hardware device 8 principally with at least one finger, thumb, or secondarily another part/portion of the body, or object near the body, such as clothing, a strap, a belt, necklace, or other unlimited methods on at least one hand based on any type of design, style, configuration, material, approach, methodology, reasoning, purpose, including at least one part, piece, component, unit, extension, accessory or alike, rather than a persons hand, wrist, forearm, arm, waist, leg, hip, head, neck, or other parts of the body.

At least one preferred method and style can be utilized for holding, hanging, carrying, and/or attaching at least one type and/or portion of at least one type of finger held hardware device 8. The primary purpose of demonstrating at least one method of achieving this objective, as provided in the illustration in FIG. 8, at least one user can hold/attach/connect or engage 2 with at least one finger, thumb, or other portions of the body, and/or other devices or means that would allow at least one user to bring, carry, hold, or have, bring or carry at least one type of finger held hardware device 8 and/or any other type of hardware device, network card device, media device, and/or other such types of hardware devices. At least one type of button such as those found in FIG. 8 located on this illustration and number as buttons 3, 10, & 11 can be designed at the factory level to be of any number of buttons, any size, any style, any design, any form, any format, any color, any shape, any material, and/or a plethora of variations that has any type of image, name, or reference on any such buttons 3, 10, & 11.

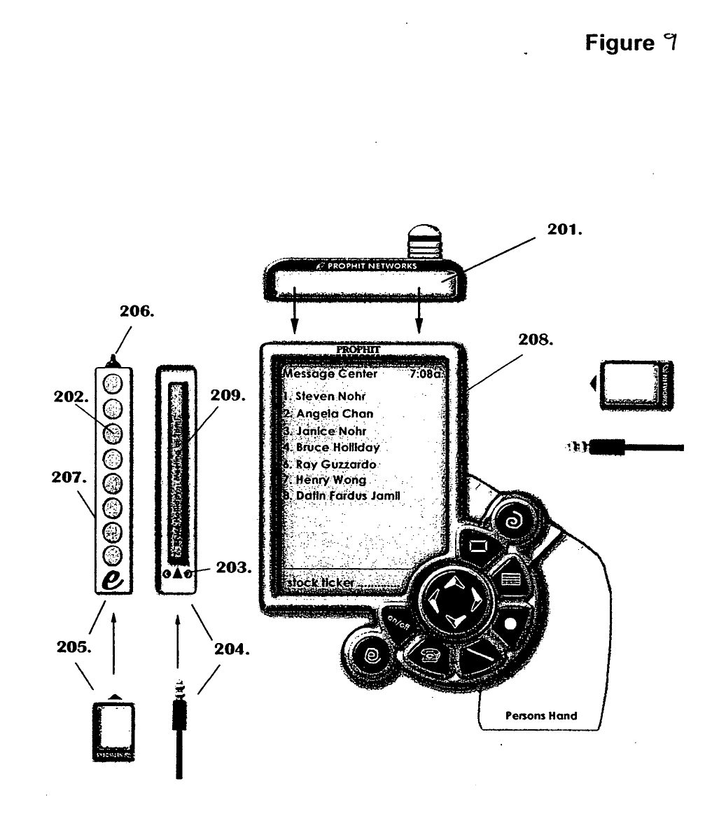

FIG. 9 is a front side view of a finger held hardware device(s) constructed in accordance with the invention. At least one type of finger held hardware device 208 or expansion capabilities 201 device such as network, data and information, removable media, games, network carrier and/or provider, or accessory device to name a few. Inversely, these same functions and features can be built into and comprised of within any type of finger held hardware device 208. At least one type of carrier, and/or provider can operate and/or provide such services on at least one type of spread spectrum, split spectrum, and/or multiple spectrum, from RF, IR, lightwave, and much more. Currently, all forms of wireless hardware communications devices; from cellular mobile phones, pagers, personal digital assistants, and more are manufactured to operate only on one frequency, spectrum, or carrier network. However, at least one type of finger held hardware device 208 or expansion capabilities 201 device can be designed and configured that will allow at least one user, network, carrier, provider or other party to select, modify, change, adjust, or by means that will allow it to work, operate, communicate with, utilize more than one frequency, spectrum, protocol, architecture, network, carrier, provider, or other services. The preferred method for modifying current settings are based on embedded software, graphic utility interface, button based, voice recognition interface platform. By contrast, multiple IC designs, chip and/or chip sets can be utilized in a particular design. Other methods, structures, protocols, methodologies, platforms, and configurations can be utilized for achieving one in the same result. This feature is significant when a user travels to other towns, cities, states, and countries whereby a local carrier, and/or network provider(s) content on at least one type of spectrum from the local carrier, and/or network provider(s) defaulted network connection configuration. With this type of expansion capabilities 201 design feature, more than one network or service provider can be offered to the user.

At least one type of expansion capabilities 201 can allow and/or enable signal strength by/to/from/between any type of portable terminal hardware device and any local and/or remote location, network, carrier, provider, or frequency spectrum to fluctuate based on signal strength requirements by increasing, and/or decreasing power resources or other methods and techniques that would enhance signal strength during or at times when any type of device is in or is about to enter into an area or commonly referred to as a hot spot, and inversely reducing power requirements and power usage or resources when any type of hardware device is in an area that provides optimum signal strength, thus reducing power usage and/or resources. This can be achieved by hardware, firmware or middleware, and/or software design at the hardware device level, and/or from a local and/or remote network, carrier, provider, and/or operator level.

At least one type of remote control device 207 can be designed with and/or to perform at least one type of feature to the user, either directly by and/or between at least one type of finger held hardware device 208, or other type(s) of hardware device or accessory device, or directly by, to, and/or thru any other type of device, network, carrier, or provider platform, architecture, protocol, spectrum, configuration, design, and/or other variations thereof. For the primary purpose of demonstrating at least one method of achieving this objective, as provided in the illustration in FIG. 9, at least one user can utilize the point 206 of at least one type of remote control device as an expandable and/or retractable antenna, as a pointing device, and/or as a stylus to name a few. At least one type of physical button 202 could be utilized and incorporated into the design of a remote control device 207.

At least one type of removable media 205 could be utilized and incorporated into the design of a remote control device 207. At least one type of headphone jack and/or wired data connection capabilities 204 could be utilized and incorporated into the design of a remote control device 207. At least one type of scrolling button 203 features could be utilized and incorporated into the design of a remote control device 207 that would allow and/or provide the user to facilitate such things as quickly and remotely recalling, sending; retrieving data and information, such as text messaging or paging services from/by/to/from a network, a carrier, or provider, and/or by and between at least one type of finger held hardware device 208, and/or any other type of hardware device, accessory, network card, removable media, and/or other configuration. At least one advantage to such a feature would be for at least one user to quickly check and/or look up any type of data and/or information without having to turn on any type of hardware device like a cellular mobile phone, PDA, pager unit, digital camera, stock quotes, music, or other, including a finger held hardware device 208 without actually having to physically interface directly turn ON a device to send, receive, look up, retrieve, store, recall, file, delete, exchange, trade, give, or other forms with at least one type of data and information.

At least one type of viewable screen area 209 could be utilized and incorporated into the design of a remote control device 207 to provide to the user at least one form of data and information such as numeric paging, alpha numeric paging, text messaging services of any type, and/or other types of services.

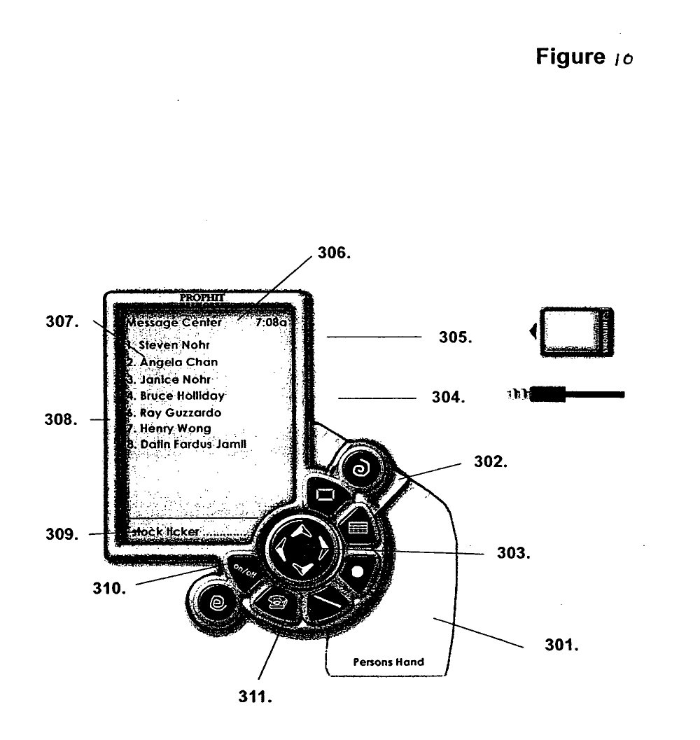

FIG. 10 purpose is to show at least one possible design and/or configuration for what could possibly be the front side view of at least one type of finger held hardware device 308 constructed in accordance with the invention. At least one type of finger held hardware device 308 could be designed to have at least one type of monochrome viewable area design 306, 307, 308, 309. At least one type of monochrome viewable area design 306, 307, 309 design could primarily be used for paging, instant text messaging, stock ticker information, text messaging service of any type, and other text based services from at least one carrier, and/or network service provider. At least one type of finger held hardware device 308 could be utilized for all types of data and communications with any and all types of content, data, and information as provided at least one carrier, provider, or product—such as a game, software program, or other.

At least one type of finger held hardware device 308, although providing a means for at least one type of user to physically turn ON/OFF 310 the device can be incorporated into a design, the finger held hardware device 308 itself upon the user entering a physical location can automatically wake up and engage in providing any and all related type(s), style(s), format(s) of content to the user, based on the user, carrier, network provider, or other parties user preferences. At least one type of finger held hardware device 308 can have the ability to turn OFF by itself as well, to save power resources or other purposes, if the user does not engage any new content after a pre-determined period of time, in which the predetermined period of time can be established by at least one party. At least one party can establish in the user preferences what type(s) of content that the user is allowed, wishes to receive, only enabling content in pre-identified categories to be sent/received, as well as blocking any and all other types of content that the user does not wish to receive, or is allowed to receive. At least one party (carrier, provider, and/or user) can be given the ability to save, store, view, exchange, recall, trade, delete and alike all authorized content that is provided to at least one users hardware device by actively facilitating these requests themselves on an active or passive basis. Content can be saved at the location that has been pre-selected by the carrier, provider, and/or user, whether it be at the hardware device location, locally, and/or remotely, and whether it be internally, externally, and/or removable. At least one carrier, provider, and/or user may elect to save content locally, and can utilize any type of removable media storage 305. At least one type of antenna can be built into at least one type of designed finger held hardware device 308. At least one purpose of the antenna is to improve the signal strength, and coverage area to reduce to the furthest extent hot spots, dropouts, and disconnections while the user is operating the finger held hardware device 308. At least one type of finger held hardware device 308 design can also provide unlimited number of other types of content, entertainment, and information such as; playing electronic games of all types, styles, and formats, digital content, music, media and entertainment, camera features, video, professional services, information content, location means, network access means, and all types of content and services that can be provided to a user(s). At least one type of user has the ability to save content on a local and/or remote network.

At least one type of finger held hardware device 308 can have the ability and expandability for the users to facilitate its interaction requests with the finger held hardware device 308 from a remote control unit as well. Interaction can include basic navigation, interacting with user preference settings, selection and decision of saving, deleting, recalling, viewing, exchanging, trading, any pre-stored content, stopping transmission of any type of content, selection of other categories, and/or subcategories including but not limited to phone, calendar, VP Collect, image Gallery, email, text messaging, message center, keyboard, scrolling, software categories, general section, plug-in, expansion slot, duel or split spectrum capabilities, and features.

At least one type of finger held hardware device 308 can have the ability to provide at least one user a viewable screen area 306, 307, and 309 area to view any and all content. The viewable screen area 307 could be utilized as a single screen design, or as a duel or multiple screen design, so that different forms of content can be provided to different portions of the viewable screen area 307.

One example can include stock ticker information being provided to the user in viewable screen area 309 while other types of content, such as text messaging information is being provided to the screen in viewable screen area 306, while the user is interacting with any type of data and information in the middle viewable screen area 307. In this way, the user is able to multi-task several things at the same time. These different types of content can either be connected and related, or separate in purpose, function, information, and design. The user, carrier, and/or provider can also move, change, and/or modify various types of content to other locations on the viewable screen area 307 at any time.

At least one type of speaker and/or microphone can be incorporated into the design of the finger held hardware device 308 to provide all types of sound capabilities. FIG. 10 illustration has the speaker located on the backside of the finger held hardware device 308. At least one type of LED and/or lighting up of at least one type of button 303, 310, and 311 to assist the user at night and dark lit locations. The LED features can be utilized to inform the user power resource levels, as well as if the finger held hardware device 308 is ON, in sleep mode, or OFF.

At least one type of finger held hardware device 308 can be converted and utilized as a digital camera, video camera, wireless phone, cellular mobile phone, pager, PDA, music player, CD player, DVD player, video camera, game player, as well as a host of other hardware device capabilities. At least one type of finger held hardware device 308 can be designed to incorporate any type of wired connection and/or headphone jack 304. At least one type of physical or non-physical volume control can also be configured into the design of finger held hardware device 308 for user convenience.

At least one type of strap(s) 302 can be incorporated into the design of a finger held hardware device 308 used for the user to hold, hang, attach, connect with a finger held hardware device 308, or as an accessory to any such device, or accessory.

Middle buttons 303 can be configured and utilized for up, down, left, and right scrolling, navigation, directory, sub-directory, and other command sets that the manufacturer, carrier, provider, and/or user can configure chooses for these buttons. These middle buttons 303 can allow user a user to play all types of games on the finger held hardware device 308. At least one type of physical ON/OFF button 10 can be utilized to override sleep mode, and wake mode features that are set as defaulted on a finger held hardware device 308. If a user wishes, they can actively change these settings, and/or override the defaulted features at any time. When the finger held hardware device 308 is in sleep mode, the finger held hardware device 308 can automatically wake up by itself when a user physically moves around a building, town, city, state, or country, whereby all types of content will (actively, and passively) be provided to the user—waking up the finger held hardware device 308 to allow the user to interact with the related content. If after a certain period of time, the user has not interacted with the finger held hardware device 308, and/or no new content is being provided to the finger held hardware device 308, the finger held hardware device 308 may automatically go into sleep mode to conserver power resources. The user can configure the finger held hardware device 308 so that when both sleep mode, and wake mode are commenced, the finger held hardware device 308 can provide the user with at least one type of [audible], [visual], [motion or vibration], or other means of notification.

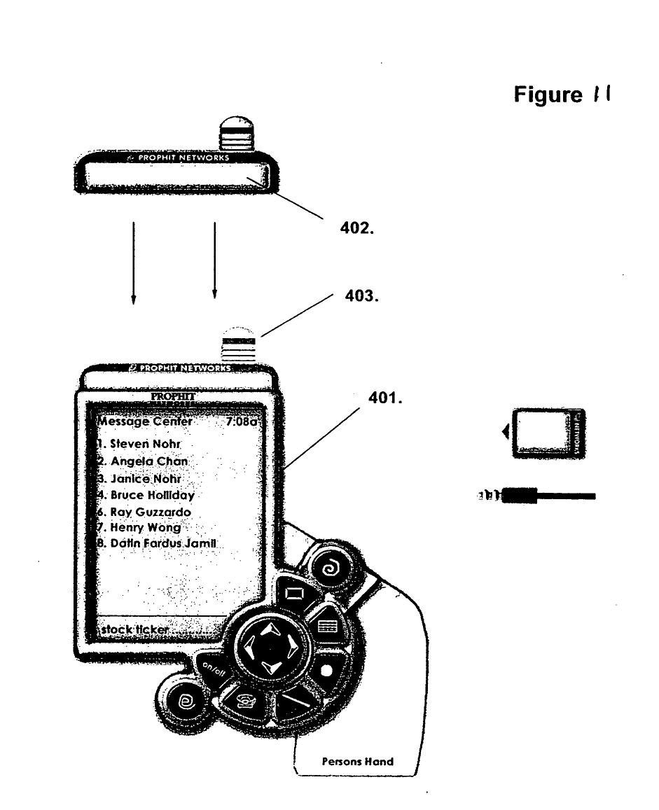

FIG. 11 is a front side view of a finger held hardware device 401 constructed in accordance with the invention. The monochrome finger held hardware device 401 has expansion capabilities 402 to provide to the user at least one type of carrier, network, or provider services. This feature is significant when a user travels to other towns, cities, states, and countries whereby the network provider(s) content is on a different spectrum, or duel/split spectrum from the units defaulted network connection configuration. With such expansion capabilities 402 design feature more than one network or service provider can be offered. The purpose of the illustration in FIG. 11 is to show what expansion capabilities 403 looks like when connected to at least one type of finger held hardware device 401.

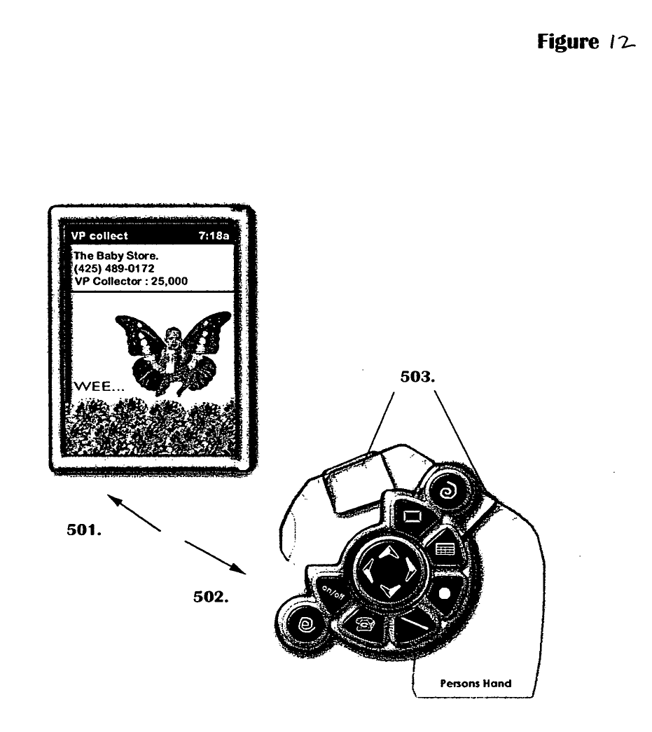

FIG. 12 is a front side view of a finger held hardware device 501, 502, and 503 constructed in accordance with the invention. The purpose of illustration FIG. 12 is to show that at least one type of finger held hardware device 501, 502, 503 can be separated, and/or the user is able to detach at least one portion of a finger held hardware device 501, 502, 503 from another portion of a finger held hardware device 501, 502, 503 design. For the purposes of illustration, the viewable screen portion 501 of a finger held hardware device 501, 502, 503 can be removed, separated, taken away from another portion of a finger held hardware device 501, 502, 503, such as the finger held navigation buttons 502 portion of the device.

This enables at least one user to remove the viewable screen portion 501 and place, connect, interact a different viewable screen; such as a larger one, a different viewable screen with a different embedded software and system that provides characterizes or features to at least one users viewable screen apparatus to the device. At least one type of user can now send, give, trade, exchange, the viewable screen portion 501 with at least one other user.

At least one type of viewable screen portion 501 can be designed with at least one type of electromechanical technologies, circuit board design, IC design, CPU, processor, chip or chip set, sound and/or graphics capabilities, memory, hard drive and/or data storage capabilities; power resources, OS, software, middleware, any type of ports, as well as any and all other components that would allow the viewable screen portion 501 to provide any and all of the same functions as any type of other device, including but not limited to a desktop computer, laptop, notepad, PDA, cellular phone, telephone, pager, music player, camera, video device, data storage device, scanning device, reading device, and all other types of devices.

Any type of viewable screen portion 501 has the capability to provide to at least one user, any and all types of functions and features as any type of hardware device stated hereto in this patent documentation. In one particular design, the viewable screen portion 501 can be detached from the navigation button 502 portion of the original finger held hardware device 501, 502, 503, and/or other portions of a hardware device, and given to at least one other user, and for the receiving user to be able to turn ON and utilize the viewable screen portion 501 as an entire fully functioning hardware device, without requiring connection with any other type of physical hardware device, or apparatus. The same full range of services can be provided to the receiving user as with the original user. Any and all types of data, information, inputting/outputting, data—viewing, storing, recalling, filing, modifying, utilization of all types of content such as; music, video, games, and photos, text based data, and all types of communications can be provided on just the viewable screen portion 501.

At least one type of finger held hardware device 501, 502, 503 can utilize at least one type of removable navigation button 502 configuration and/or apparatus to interact with at least one type of hardware device, or accessory device.

At least one type of user can utilize, send, give, trade, exchange, connect, interact, interface, and alike with navigation button 502 with at least one other user. At least one type of navigation button 502 can be designed with at least one type of electromechanical technologies, circuit board design, IC design, CPU, processor, chip or chip set, sound and/or graphics capabilities, memory, hard drive and/or data storage capabilities, power resources, OS, software, middleware, any type of ports, as well as any and all other components that would allow the viewable screen portion 501 to provide any and all of the same functions as any type of other device, including but not limited to a desktop computer, laptop, notepad, PDA, cellular phone, telephone, pager, music player, camera, video device, data storage device, scanning device, reading device, and all other types of devices.

At least one type of strap(s) 302 can be incorporated into the design of a navigation button 502 for the user to hold, hang, attach, connect with navigation button 502, and/or as an accessory to any such device, or accessory.

Any type of navigation button 502 has the capability to provide to at least one user, any and all types of functions and features as any type of hardware device stated hereto in this patent documentation. In one particular design, the navigation button 502 can be detached from the viewable screen portion 501 portion of the original finger held hardware device 501, 502, 503, and/or other portions of a hardware device, and given to at least one other user, and for the receiving user to be able to turn ON and utilize the navigation button 502 as an entire fully functioning hardware device, without requiring connection with any other type of physical hardware device, or apparatus. The same full range of services can be provided to the receiving user as with the original user. Any and all types of data, information, inputting/outputting, data—viewing, storing, recalling, filing, modifying, utilization of all types of content such as; music, video, games, and photos, text based data, and all types of communications can be provided on just the navigation button 502.

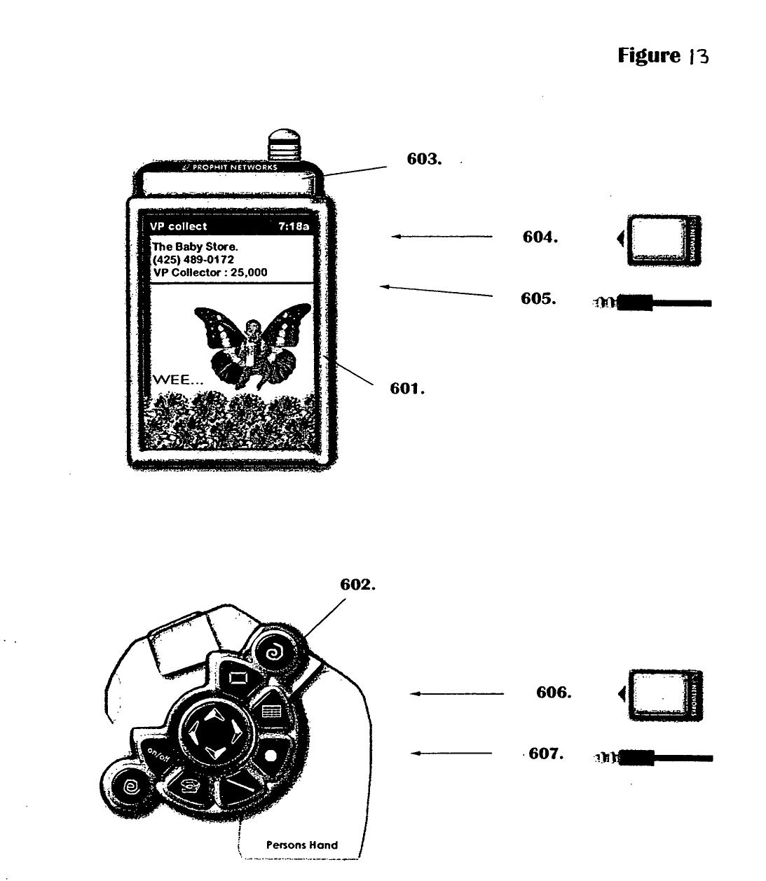

FIG. 13 is a front side view of a finger held hardware device 601, 602 constructed in accordance with the invention. The purpose of illustration in FIG. 13 is to illustrate or demonstrate that at least one type of viewable screen area 601, and/or navigation button 602 apparatus can be designed, configured, and made to include at least one type of capability that will provide to a user at least one type or form of removable medium 604, and 606, as well as wired data connection and/or headphone capabilities 605, and 607. One particular design and configuration for a viewable screen area 601 can also have the capability to provide the user with at least one type or form of network, carrier, and/or provider 603 means. Navigation button 602 can also be designed and configured to also have the capability to provide the user with at least one type or form of network, carrier, and/or provider 603 means. At least one type of navigation button 602 can also include a viewable screen area as part of its primary design, so that in such cases when at least one user were to remove a primary viewable screen area 601, the navigation button 602 can still retain a viewable content area.

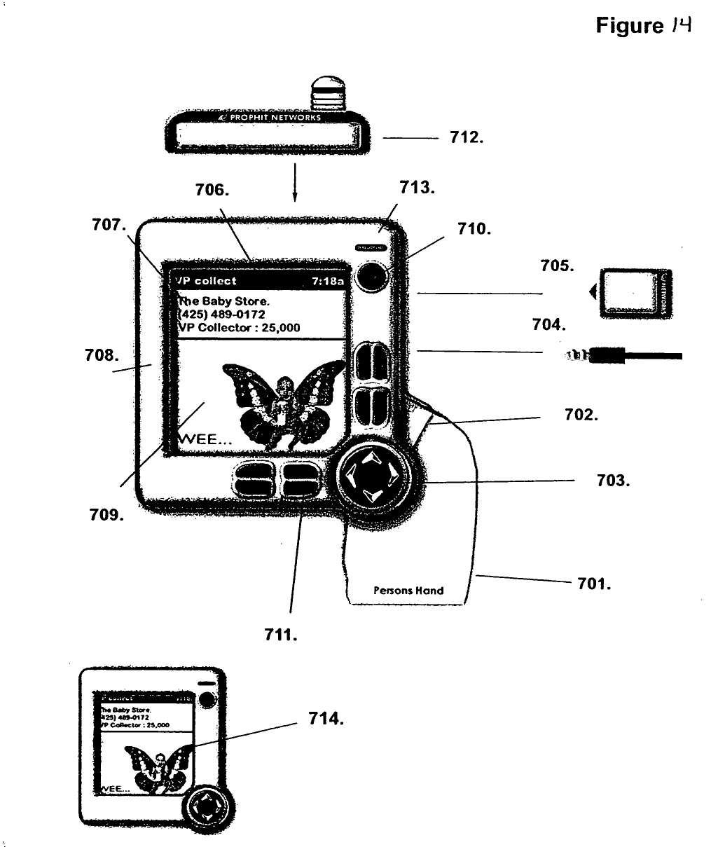

FIG. 14 is a front side view of another modified, configured, and designed finger held hardware device(s) 708 and also shows a persons hand 701 for the express purpose of providing additional sample variations that can be constructed in accordance with the invention. This particular finger held hardware device 708 can equally be utilized in providing, inputting, sending, receiving, interacting, storing all types of content, communications with any and all content, data, and information from internal means and methods, and/or from external means, and/or methods. Services can include network(s) provider(s) medium 712 to any type of configured finger held hardware device(s) 708 with any and all content that is provided from the network(s) provider(s). The finger held hardware device 708 can interact, receive, save, store, erase, exchange, or trade all types of content. User(s) finger held hardware device 708 can turn ON/OFF 710 physically at anytime.

At least one type of finger held hardware device 708 has the capability to turn ON and OFF by itself, from sleep mode, to wake mode when the user(s) receives any types of content. At least one type of finger held hardware device 708 has the ability to turn OFF by itself as well, to save power resources or other purposes, if the user does not engage any new content after a predetermined period of time, that is established by the user within the user preferences of the finger held hardware device 708, and/or by setting up user preferences by the network provider, and/or user at the network level by many methods. Users can establish in the user preferences of the finger held hardware device 708 what type(s) of content that the user wishes to interact with, allowing content in pre-identified categories to be sent to the users finger held hardware device 708, as well as blocking, limiting, filtering, and/or restricting any and all other types of content that the user does not wish to receive directly, or to be sent to a remote location where the user is able to access by wired, wireless, and/or combinations thereof, such data and information at a later point in time.

At least one user can save, store, view, communicate, exchange, recall, trade, delete and alike all types of content that the finger held hardware device 708 offers to the user(s). Content can be saved locally inside and/or outside of the finger held hardware device 708, and/or remotely that has been provided by at least one carrier, and/or network provider(s). If the user selected to save content locally, the content could be saved internally, externally, and/or be saved onto removable media storage means 705. At least one type of wired connection and/or headphone jack 704 can be utilized with the finger held hardware device 708. At least one type of antenna can be built as part of or in addition to the finger held hardware device 708. The primary purpose of the antenna is to improve the signal strength, and coverage area to reduce to the furthest extent hot spots, dropouts, and disconnections while the user is operating the finger held hardware device 708.

At least one type of finger held hardware devices 708 may have the ability and expandability for the users to facilitate its interaction requests with the finger held hardware device 708 from a remote control unit as well. Interaction buttons 703, 710, & 711 can include basic navigation, interacting with user preference settings, selection and decision of saving, deleting, recalling, viewing, exchanging, trading, any pre-stored content, stopping transmission of any type of content, selection of other categories, dialing phone numbers, sending and receiving email, instant messaging services, stock ticker information, and other professional services, and/or subcategories including but not limited to phone, calendar, VP Collect, VP Gallery, email or message center, keyboard, scrolling, software categories, general section, plug-in, expansion slot, duel or split spectrum capabilities, and features.

At least one type of finger held hardware device 708 can have the ability to provide at least one user a viewable screen area 706, 707, and 709 area to view any and all content. The viewable screen area 707 could be utilized as a single screen design, or as a duel or multiple screen design, so that different forms of content can be provided to different portions of the viewable screen area 707. One example can include stock ticker information being provided to the user in viewable screen area 709 while other types of content, such as text messaging information is being provided to the screen in viewable screen area 706, while the user is interacting with any type of data and information in the middle viewable screen area 707. In this way, the user is able to multi-task several things at the same time. These different types of content can either be connected and related, or separate in purpose, function, information, and design. The user, carrier, and/or provider can also move, change, and/or modify various types of content to other locations on the viewable screen area 707 at any time.

At least one type of finger held hardware device 708 can also provide an unlimited number of other types of content, entertainment, and information such as; playing electronic games of all types, styles, and formats, digital content, music, camera features, video features, professional services, information content, location means, network access means, and all types of content and services that can be provided to a user(s).

These different types of content can either be connected and related, or separate in purpose than the primary intended data and/or information. At least one type of speaker can be part of, or in addition to at least one type of finger held hardware device 708 design. At least one type of LED 713 and/or lighting up of at least one button 703, 710, and 711 can be utilized to assist the user at night and dark lit locations, or as a form of notification. These forms of notification can be part of the carrier, or provider network services, and/or can be configured by a user by various types of hardware and/or software configurations either directly on the finger held hardware device 708, and/or remotely by a multitude of other avenues. At least one LED 713 feature can be utilized to inform the user about power resource level, as well as if the finger held hardware device 708 is ON, in sleep mode, OFF, as well as incoming data, communications, and information, or pending outgoing data, communications, and information, including file size, download, upload, and/or data transfer timeframe. At least one type of microphone can equally be incorporated into the finger held hardware device 708.

At least one type of finger held hardware device 708 might have the capability to be converted and utilized as a digital camera, video camera, wireless phone, cellular mobile phone, pager, PDA, music player, CD player, DVD player, as well as a host of other hardware device capabilities. At least one type of finger held hardware device 708 can be designed with a headphone jack and/or wired data and communications plug in 704 on the device that can allow a user the ability to utilize any type of headphone, as well as wired data transfer capabilities. At least one type of volume control for the control of sound levels can also be made available internally, externally, and/or combinations thereof as part of, or in addition to a finger held hardware device 708 for user convenience.

At least one type of configurable strap 702 can be designed as part of, and/or in addition to a finger held hardware device 708. Such a feature can primarily be utilized by the user to hold onto the finger held hardware device 708 from at least one finger, and/or thumb of a users hand 701 and/or other portion of the user body, clothing, belt, or alike, and/or other means of attaching or allowing the user to bring the finger held hardware device 708 with them.

The bottom right buttons 703 in FIG. 14 can be utilized for navigation, for up, down, left, and right, scrolling, directory, sub-directory, data inputs and outputs, and other command sets that the manufacturer, carrier, service provider, and/or user decides to offer, is made available, and/or selects from user preferences for operating the finger held hardware device 708, and/or other interrelated devices that can be wired, and/or wireless, such as a network card, smart card, removable media, scanning, pointing, or reading device, memory device, camera device, video device, and music device to name a few. The bottom right buttons 703 can also be utilized to allow at least one user to play all types of games on the finger held hardware device 708. Besides typical physical game cartridges, other methods can be achieved by downloading the software game by various wired and/or wireless means to an internal, and/or external data storage location that does not require and/or utilize a removable media commonly utilized within the hand held game market.

At least one type of ON/OFF button 710 can override the sleep mode, and wake mode features that are set as defaulted in the finger held hardware device 708. If the manufacturer, carrier, service provider, and/or user wishes, any can passively and/or actively change these settings, and/or override the defaulted features at any time.

If a finger held hardware device 708 is in sleep mode, the finger held hardware device 708 can automatically wake up by itself when a user physically moves around a building, town, city, state, or country, whereby all types of content will (actively, and passively) be provided to the user—waking up the finger held hardware device 708 and allow the user to interact with the related content. If after a certain period of time, the user has not interacted with the finger held hardware device 708, and/or no new content is being provided to the finger held hardware device 708, the finger held hardware device 708, the carrier, service provider, and/or finger held hardware device 708 can automatically go into sleep mode to conserver power resources. The user can configure the finger held hardware device 708 so that when both sleep mode, and wake mode are commenced, the finger held hardware device 708 can provide the user with a [audio], [visual], [motion or vibration], or other means.

There are a plethora of ways, means, and methods for a user to hold onto the finger held hardware device 708 by use of the users fingers, thumb, or other means other than the entire hand. The preferred styles, as provided in the illustration, slides onto the to pointing finger of a users hand 701 at the lowest extension of the pointing finger by at least one type of configurable strap 702, and could possibly also have a second on the extension of the pointing finger section of an adjustable, flexible, and configurable strap 702 to provide balance to the user while utilizing the device(s). A strap 702, can be made of any type of material(s), combination of materials, of any size, shape, color, whether fixed, or flexible by design or function, or variations thereof achieving one in the same in whole and/or in part.

At least one type of physical navigation button 703, 710, & 711 can be designed at the factory level, and/or added by aftermarket products offered to a user that would be comprised of any number of buttons, any size, style, design, form, format, color, shape, that has any type of image, name, or reference on any such buttons 703, 710, & 711.

Likewise, these physical navigation and interaction buttons can be non-physical by design, function, and nature, and can be configurable in a plethora of platforms, configurations, protocols, and architectures utilizing various means of achieving one in the same by at least one carrier, service provider, and/or user.

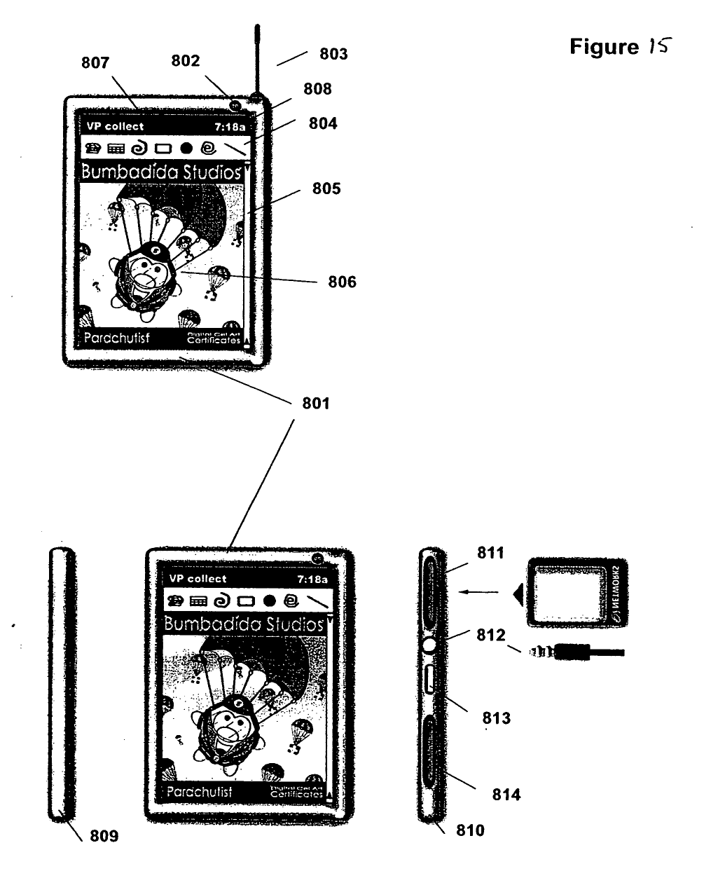

FIG. 15 is a front, left and right side view of another modified, configured, and designed viewable screen device 801 for the express purpose of providing additional sample variations that can be constructed in accordance with the invention. At least one type of viewable screen device 801 and/or any type of physical device can be designed with the following capabilities and features. This particular viewable screen device 801 does not have any physical navigation, or main category buttons, whereby all of these functions and features are provided to the user after the user turns ON 802 the viewable screen device 801. All buttons 804 are non-physical by design and show up in this particular example on the upper portion of the viewable screen device 801. The user can be provided information such as what category or category identification 807 they are utilizing at the moment, as well as date and time 808 information. The viewable screen device 801 can have an antenna apparatus 803 for communications with any type of external device, carrier, network, provider, or alike. At least one type of viewing area 806 can be incorporated into the viewable screen device 801. At least one type of scrolling capability 805 can also be incorporated into the design of the viewable screen device 801. At least one type of removable media 811, headphone jack 812, and/or wired data and communications plug in 813 capabilities can be incorporated into the design. At least one type of port 814 capabilities can be incorporated into the design. A right side view 810 and left side view 809 of at least one type of viewable screen device 801 is provided in this illustration.

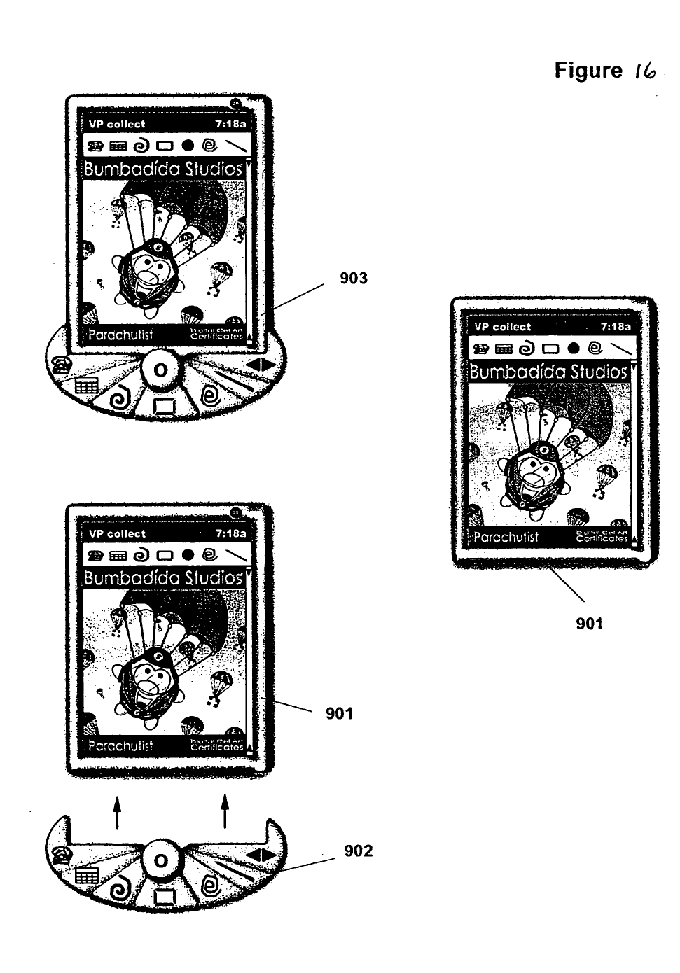

FIG. 16 is a front side view of another modified, configured, and designed viewable screen device 901 for the express purpose of providing additional sample variations that can be constructed in accordance with the invention. At least one type of viewable screen device 901 and/or any type of physical device can be designed with the following capabilities and features. This particular viewable screen device 901 can be designed with the capability to interact and/or be connected to at least one type of physical navigation button apparatus 902 that connects from the bottom, rather than the prior side portion and/or back of the viewable screen device 901 in prior FIGS. 8, 9, 10, 11, 12, and 13, which illustrates flexibility in design, and configuration.

At least one user is then able to utilize multiple types, forms, styles, functions, capabilities of button apparatus 902 devices for achieving the same, or different objectives and purposes. Since button apparatus 902 devices can be designed, configured, and made with all the necessary CPU, processor, chip or chip set, memory, hard drive and/or data storage capabilities, software, graphic utility interface, middleware, OS, and even network accessibility, a user can utilize different types of button apparatus 902 devices to perform a specific and/or unique set of functions, or a single button apparatus 902 device to perform any and all user required functions.

Viewable screen device 903 shows what it could look like when one particular design of viewable screen device 901 and button apparatus 902 are connected together.

FIG. 16 is a front side, and back side view of another modified, configured, and designed viewable screen device 1006 for the express purpose of providing additional sample variations that can be constructed in accordance with the invention. At least one type of viewable screen device 1006 and/or any type of physical device can be designed with the following capabilities and features. This particular viewable screen device 1006 can be designed with the capability to provide to the user at least one type of gel pad 1001, 1002, 1003, and 1004. At least one type of gel pad can be designed, configure, and applied at the manufacturing level, wholesale, distributor, dealer, user or other as part of the primary viewable screen device 1006 and/or in addition to, as an accessory. A least one type of Gel pad can be applied to the back 1001, front 1003, side 1004, or middle 1001, 1002 of/to any type of device. At least one type of gel pad can include at least one type of logo, marking, icon, name, illustration, or facsimile thereof 1002, whether the logo or alike is gel pad based or not. At least one type or speaker/microphone 1005 can be incorporated into the design of a device.

At least one purpose for the gel pad is to provide a means for any type of hardware device not slipping around or slippery in a person's hand, on a counter, or all other forms. The gel pad provides a grip to any surface, object, or alike that is currently not available with any type of hardware device, whether it be a pager, mobile phone, cellular mobile phone, PDA, CD player, MD player, DVD player, cassette player, camera, video player, data inputting device, portable terminal device, and all other types of devices and apparatuses. At least one other purpose for the gel pad is to provide shock protection or shock reduction in cases where a user were to drop any type of device. At least one other purpose for the gel pad is to reduce the effects of heat from external and/or internal generated.

At least one other purpose for the gel pad is to make it easier for a user to hold onto any type of device. At least one other purpose for the gel pad is so that any type of device does not slide off of a surface that it has been set on; such as a counter top, table, desk, or alike, which are traditionally slick and smooth surfaces.

A Gel pad can be made, comprised, configured, designed, and produced in/of at least one type and/or combination of color, size, shape, substance, material, in any form or format, procedure, technique, methodology, made to last a specified timeframe, smell, be modified from hard to soft, or soft to hard, or anything else.

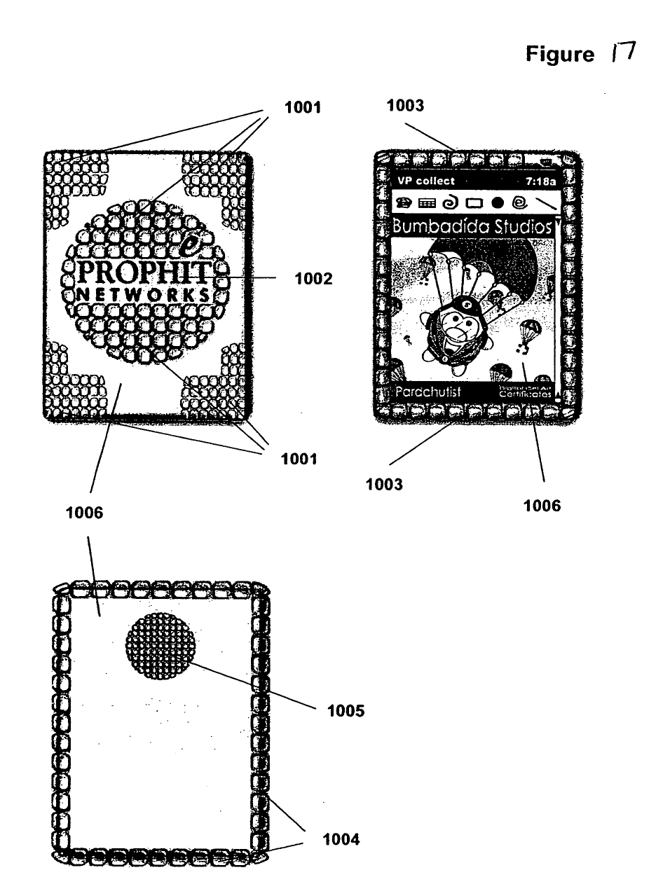

FIG. 17 is a front, left side, right side, and back side of another modified, configured, and designed viewable screen device 1101 for the express purpose of providing additional sample variations that can be constructed in accordance with the invention. At least one type of viewable screen device 1101 and/or any type of physical device can be designed with the following capabilities and features.

The purpose of FIG. 17 is to illustrate and show at least one way of producing a viewable screen device 1101 that does not have any physical buttons at all. The viewable screen device when turned OFF can possibly look like 1101(a), illustrating that there is no external way for at least one user to utilize the viewable screen device without permission. The viewable screen device when turned ON can possibly look like 1101(b), illustrating that only upon at least one user is able to turn ON the device by non-physical means are they able to gain access to navigation buttons 1104, main category 1107 information, date and time 1108 information, scrolling 1105 capabilities, and at least one type of content 1106 area. The left side 1102 and right side 1103 provides at least one possible way of designing, designing such a device.

The above function can be designed, incorporated, configured, made, and/or provided as all other forms of devices, including but not limited to—a camera, video, wireless phone, cellular mobile phone, text messaging device, a pager, walki-talkie, trunk radio, PDA, music player, a reader device, scanner device, cassette player, CD player, DVD player, desktop computer, laptop computer, notepad device, computing device, data inputting device, communications device, data storage device, as well as a host of other types of hardware devices.

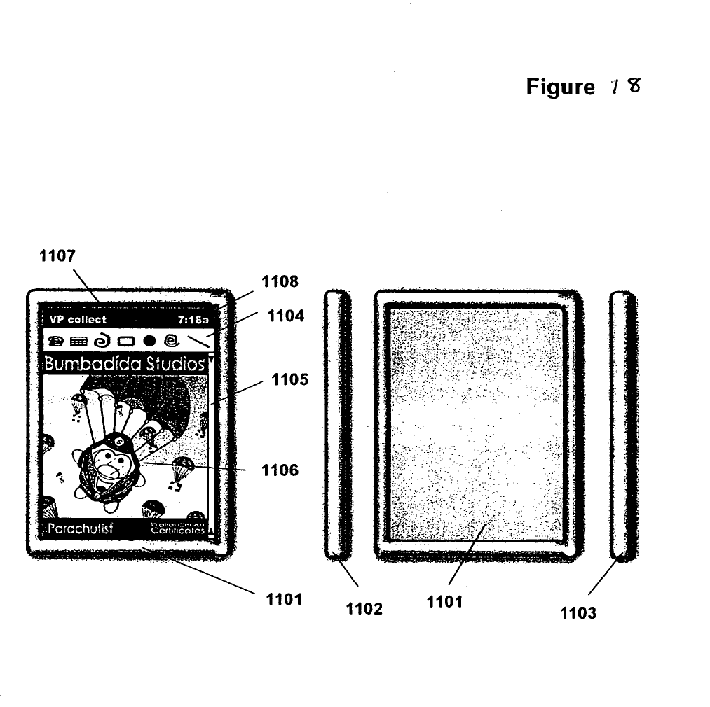

FIG. 18 are front side views of other modified, configured, and designed viewable screen device 1201 and/or finger held hardware device 1201 for the express purpose of providing additional sample variations that can be constructed in accordance with the invention. At least one type of viewable screen device 1201, finger held hardware device 1201 and/or any type of physical device can be designed with the following capabilities and features. The purpose of FIG. 18 is to illustrate and show at some ways, variations, and methods for producing a viewable screen device 1201, finger held hardware device 1201 and/or any type of physical device that does not have any physical buttons at all, but at least one user is able to utilize at least one method to gaining access, whether stated hereto or not.

The first example is by utilizing any type of key 1202 to gain access to any type of device. At least one type of key design or configuration can provide at least one variable to access any type of device.

Another possible method may be utilizing at least one type of fob 1203 as a means to gain access to any type of device. At least one type of fob design or configuration can provide at least one variable, code, authorization technique, data and/or information, protocol, platform, or alike for access any type of device.

Another possible method may be utilizing at least one type of CPU (RAM, ROM, EEPROM) 1204, RFID, IRID, or ID as a means to gain access to any type of device. At least one type of CPU or ID design or configuration can provide at least one type of variable, code, authorization technique, unique code or sequence of codes, data and/or information, protocol, platform, or alike for access any type of device.

Another possible method may be utilizing at least one type of cryptic/algorithm 1207 as a means to gain access to any type of device. At least one type of cryptic/algorithm, user name, password, design or configuration can provide at least one variable, code, authorization technique, data and/or information, protocol, platform, or alike for access any type of device.

Another possible method may be utilizing at least one type of voice recognition and/or biometric 1206 as a means to gain access to any type of device. At least one type of voice recognition and/or biometric design or configuration can provide at least one variable, code, authorization technique, data and/or information, protocol, platform, or alike for access any type of device.

The purpose of 1205 in FIG. 18 is to illustrate at least one way in which any of the above methods could look like in physical form, if a technique were to require physical interact to authorize, authenticate turning ON the device, and/or maintaining the device in ON mode, or a means of utilizing at least one type of non-physical authorization and/or authentication means near and/or close in proximity to at least one type of device, and/or accessory, or send by local and/or remote network, carrier, and/or provider means.

Any and all types and techniques, whether stated hereto in illustration form or not, can utilize physical, and non-physical means for achieving one in the same effect, whether in whole, and/or part, and/or in combination with at least one other step, procedure, method, configuration, procedure, protocol, algorithm, biometric sensing, scanning, reading, or other technique. At least one of the stated capabilities can be designed, incorporated, configured, made, or provided in all other forms of devices to at least one type of user, including but not limited to—a digital camera, video camera, wireless phone, cellular phone, text messaging device, a pager, walki-talkie, trunk radio, PDA, music player, a reader device, scanner device, cassette player, CD player, DVD player, desktop computer, laptop computer, notepad device, computing device, data inputting device, communications device, data storage device, as well as a host of other types of hardware device capabilities.

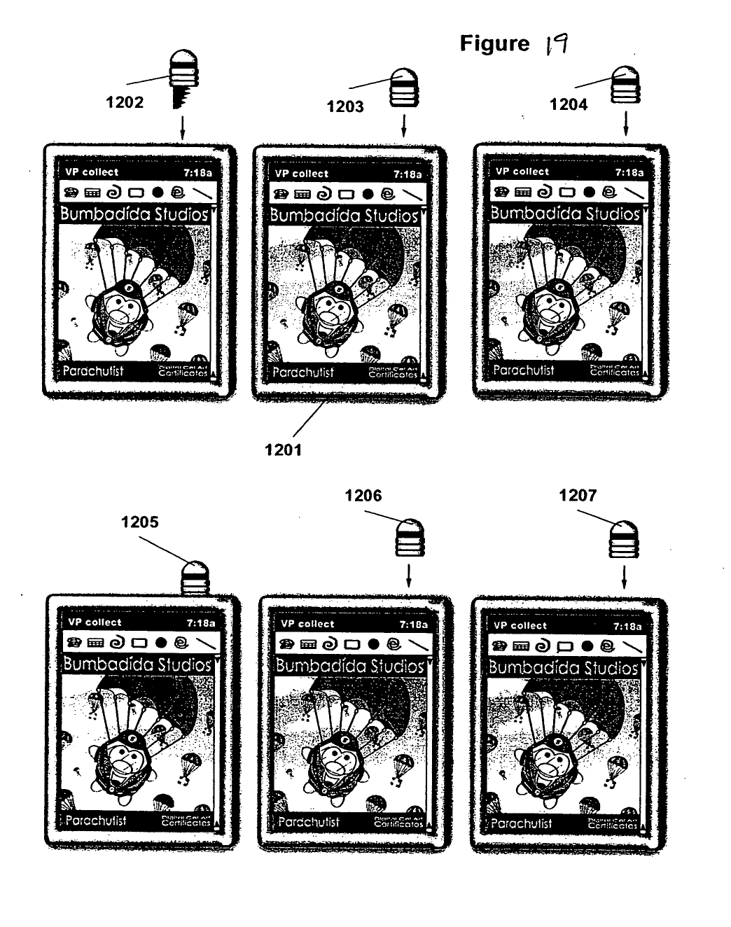

FIG. 19 is a front, side, and back view of another modified, configured, and designed viewable screen device 1301 for the express purpose of providing additional sample variations that can be constructed in accordance with the invention. At least one type of viewable screen device 1301, and/or any type of physical device can be designed with the following capabilities and features. The purpose of FIG. 19 is to illustrate and show some ways, variations, and methods for at least one user to gain access to at least one type of device, and design that does not have any external physical buttons.

The first example is by utilizing any type of RFID techniques to non-physically confirm, authenticate, authorize, and approve at least one user to gain access to any type of device, and turn ON the device. At least one type of key design or configuration can provide at least one variable to access any type of device. For example purposes, the illustration in FIG. 19 shows an RFID tag incorporated into say a bracelet or band design 1302, although any type of configurable means is possible that achieves on in the same, and the spirit of the stated invention. The RFID tag can be of any passive, active, or other variation, can include at least one type of antenna or not, at least one type of power source or not, at least one type of cryptic/algorithm, user name, password, design or configuration can provide at least one variable, code, authorization technique, data and/or information, protocol, platform, at least one type of other material, substance, or alike to adhere to, attach to, affix to, or alike.

Inversely, the design can incorporate at least one type of barcode, any other technology, or technique for achieving one in the same objective, and more.

Another possible method could include an apparatus that is comprised of the primary wireless communications protocol, and requirements that are built into a ring device 1303, or even a key chain 1304 device, or any other type of object.

A second possible method for turning ON and/or OFF any type of device, can be based on any type of remote signal on any wireless communications frequency spectrums, protocols, architecture, algorithms, configurations, carrier, provider, and/or platform, where at least one carrier, provider, or user can facilitate, engage, enact, request, perform, or alike transmit, send, receive any type of signal that would turn ON any type of device.

A third possible method could be provided by at least one user placing a call, keying in any type of numbers, letters, and/or code combinations from any type of wired and/or wireless telephone, mobile cellular phone through any type of carrier and/or provider network, whereby sending a signal, algorithm, cryptic/non-cryptic to turn ON any type of device.

A fourth possible method could be provided by at least one user sending, transmitting, remitting, signaling from any type of pager device, and/or text messaging device, through any type of carrier and/or provider network, whereby sending a signal, algorithm, cryptic/non-cryptic to turn ON any type of device. Any other type of hardware device can be utilized in whole and/or in part, as a single unit, and/or along with any type of networking accessory device, any wired network, and/or wireless network for achieving one in the same result.

At least one type of technique or method can utilize any type of wireless platform, protocol, architecture, configuration, or alike. Any and all types and techniques, whether stated hereto in illustration form or not, and/or in addition hereto, can utilize physical, and non-physical means for achieving one in the same effect, whether in whole, and/or part, and/or in combination with at least one other step, procedure, method, configuration, procedure, protocol, algorithm, biometric sensing, scanning, reading, or other technique.

At least one of the stated capabilities can be designed, incorporated, configured, made, or provided in all other forms of devices to at least one type of user, including but not limited to—a digital camera, video camera, wireless phone, cellular mobile phone, text messaging device, a pager, walki-talkie, trunk radio, PDA, music player, a reader device, a scanner device, cassette player, CD player, DVD player, desktop computer, laptop computer, notepad device, computing device, data inputting device, communications device, data storage device, as well as a host of other types of hardware device capabilities.

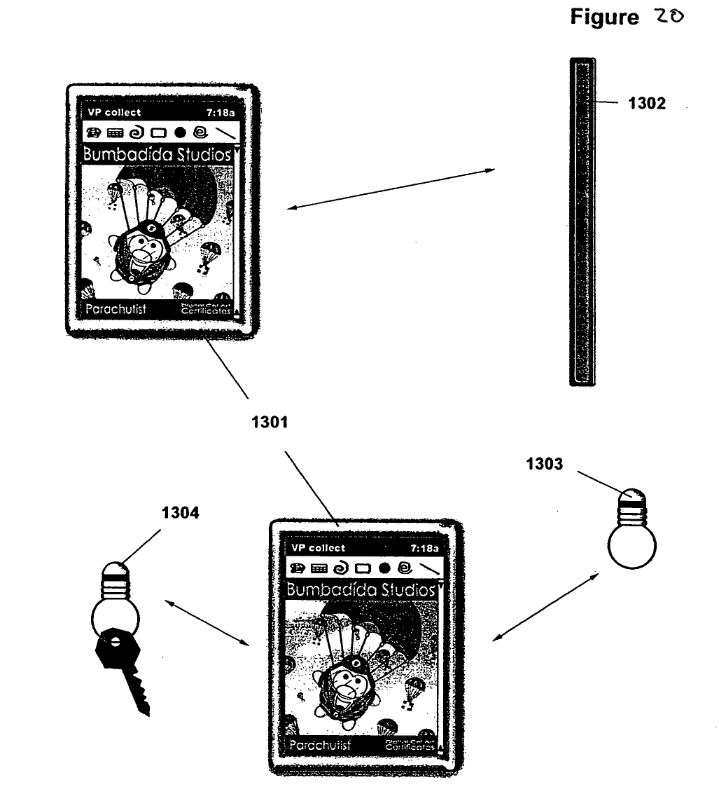

FIG. 20 is a front side view of another modified, configured, and designed finger held hardware device(s) 1402 and its possible interaction with at least one type of stand device 1401 to provide additional examples of variations that can be constructed in accordance with the invention. At least one type of stand device 1401 can be utilized and incorporated along with, and/or in addition to at least one type of finger held hardware device(s) 1402, or any other type of hardware device, or accessory device of any kind that will allow and/or provide by/thru/to/from a multitude of functions, services, and features to at least one user, carrier, and/or network provider. At least one type of viewable area, keyboard, stylus, touch or voice recognition capabilities, hard drive, memory, or other data storage capabilities can be added to any type of stand device 1401.

In the first aspect, at least one type of stand device 1401 can provide and/or allow at least one user to conveniently place/rest any type of finger held hardware device(s) 1402, a viewable screen portion 1403 of any type of device, a physical button portion 1404, or other button based design 1405 and/or any type of device, or any other configuration, design, style, or design, including network device 1407, remote control type of device 1408, or removable media 1406 capabilities.

Other advantages can include, but are not limited to, providing power resources, data storage or hard drive capabilities, wired and/or wireless data and communications, uploading, downloading, inputting and outputting of all types of data and information, printing capabilities, and any other capabilities that can be found, offered, provided made possible, including but not limited to, by any type of desktop computer device, laptop, notepad, digital camera, video camera, wireless phone, cellular mobile phone, text messaging device, a pager, walki-talkie, trunk radio, PDA, music player, a reader device, a scanner device, cassette player, CD player, DVD player, stereo system, computing device, data inputting/outputting device, communications device, data storage device, as well as a host of other types of hardware device capabilities, including internal, and/or external data storage, and/or removable media means of any type.

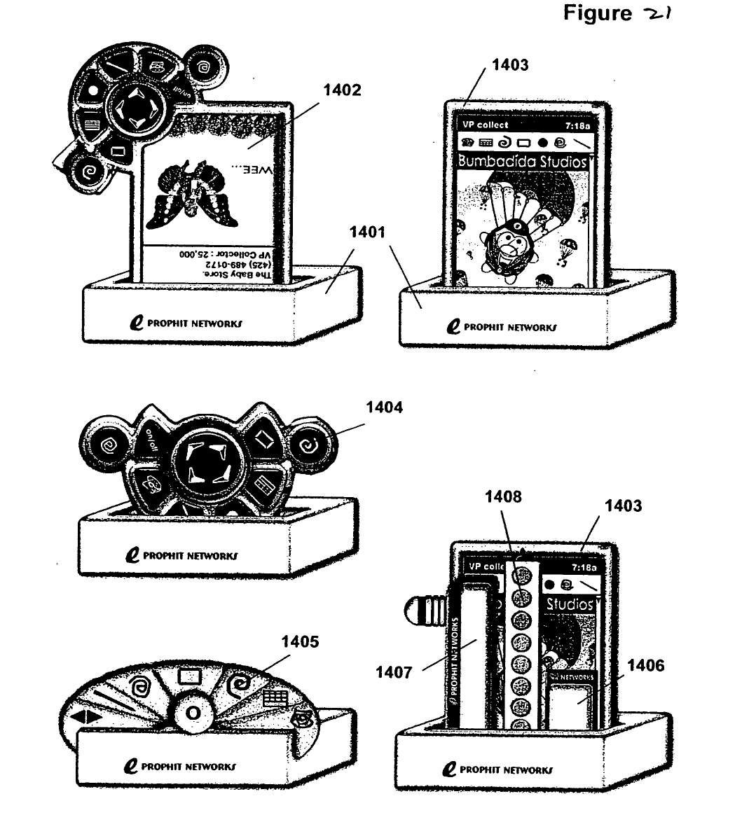

FIG. 21 is a front side view of another modified, configured, and designed stand device 1501 and its possible interaction with other types of devices, networks, carriers, providers, and users to provide additional examples of variations that can be constructed in accordance with the invention.

At least one type of stand device 1501 can be designed, configured, assembled, and incorporated and designed with at least one type internal, external, and/or removable type of primary and/or secondary board, IC design, processor, sound and/or graphics capabilities, chip or chip sets, CPU, memory, data storage or hard drive capabilities, power resources, OS, software, middleware, any type of ports, ability to provide any type of viewable screen area, any type of keyboard, stylus, or other forms of data input capabilities, microphone, speakers, as well as any and all other components that would allow the stand device 1501 to provide any and all of the functions as any type of computing device, player device, including but not limited to a desktop computer, laptop, notepad, PDA, cellular phone, scanning device, reading device, telephone, pager, music player, camera, video device, data storage device, and all other types of devices can provide to at least one type of user, as well as any of these types of devices having the ability to utilize at least one type of stand device 1501 design.

At least one type of stand device 1501 can be designed, configured, assembled, and incorporated to at least one type of viewable screen based device 1502. The Stand device 1503 shows a top view of at least one possible design, configuration, or layout, and shows at least one possible apparatus location 1504 that could be designed into any such type of stand device 1501 that would allow direct physical contact to facilitate a multitude of functions for at least one user.

At least one type of stand device 1501 can be designed, configured, assembled, and incorporated to at least one type of antenna 1505, 1512 to assist in any and all types of communication with at least one other type of device, carrier, network, and/or provider.

At least one type of stand device 1501 can be designed, configured, assembled, and incorporated to at least one type of adjustable coverage settings 1506 that can be adjusted, tuned, and modified by physical and/or non-physical means based on the installation location requirements, as well as adjusting for humidity, power resources, and other external factors that can effect the performance to assist in any and all types of communication with at least one other type of device, carrier, network, and/or provider. At least one type of stand device 1501 may have at least one type of adjustable coverage settings 1506 to control the angel of dispersion, angle scattering, and/or cone shaped dispersion for the signal transmission of a content delivery device(s). At least one type of stand device 1501 may have at least one type of internal external, and/or removable power resources 1507. At least one type of stand device 1501 can perform its communication 1508 functions based on a wired, wireless, and/or combination thereof.

At least one type of stand device 1501 can run on, in, out, thrru, by, between, from, to any type of or combination of [wired or wireless] platforms, or networks. At least one type of path, bandwidth allocation, protocol format, and/or other transmission means, such as wired transmission, (such as over a phone line, cable line, laser, photonic, copper or fiber means, power lines, local or remote network server, computer system, telephone, digital or analog wired network, local area network, optical fiber interface or network, cable network(s), or bi-directionally amplified coaxial cable interface digital subscriber lines (DSL), D1 or T1 line copper or all other types of line network or alike), and/or wireless transmission (such as over a cellular mobile phone, paging, trunk radio, laser, (RBS) radio base station network(s), satellite uplink, and/or downlink, digital or analog wireless network, WLAN, wireless cellular, paging, trunk analog or digital platforms or RF signal transmitter, satellite), whether it be analog or digital, whether it be cryptic, non-cryptic, whether it be spread spectrum, split spectrum or duel or multiple spectrums, whether it be in RF, IR, UWB, lightwave, Meghertz, Gigahertz, or any other type of frequency or spectrum utilized in providing and/or retrieving any type of data and/or information.

At least one type of stand device 1509, 1511 can be designed, configured, assembled, and incorporated to have at least one type of hardware device 1510 of any shape, design, function, purpose, and alike that can be attached and/or removed from any type of stand device 1501, 1509, 1511 or any other type of hardware device, such as a camera, video camera, wireless phone, cellular phone, text messaging, a pager, walki-talkie, trunk radio, PDA, music player, CD player, DVD player, desktop computer, laptop computer, notepad device, as well as a host of other types of hardware device capabilities.

At least one type of stand device 1501 can be designed, configured, assembled, and incorporated to allow remote control units, network cards, removable media, camera, music player and other types of accessory item slots as part of at least one type of stand device 1501 design as well.

At least one type of stand device 1501 can be designed, configured, assembled, and incorporated and designed with at least one type of wired, wireless, and/or combination thereof capabilities from/by/to/between at lease one type of carrier, network provider, service provider, or alike on any type of environment.

This means that at least one type of stand device 1501 has the capability to allow at least one type of user to interface and interact by sending, receiving, inputting, outputting, recalling, storing, filing, arranging, and alike any type of data and information from at least one type of local and/or remote network, provider, and/or user hardware device.

At least one advantage to such a structure will allow at least one user to preview a certain type of data and information and have it sent directly to its stand device 1501 so that the user does not have to carry around such data files and information with them. At least one user can at any point in time by wired and/or wireless means interface and interact with the stand device 1501 to view, recall, download, arrange, move around, modify, or interact with any such data and information.

At least one other advantage to such a structure will allow at least one user to utilize a stand device 1501 as its primary, and/or secondary data storage or hard drive location, where from time to time, at least one user can add directly or indirectly any type of data and information, as well as retrieve any type of data and information.

At least one type of hardware device, whether it fixed or mobile by design, are able to communicate and interact with all types of data and information that is on at lease one type of stand device 1501, including but not limited to any type of computing device, player device, desktop computer, laptop, notepad, PDA, cellular mobile phone, scanning device, reading device, telephone, pager, music player, camera, video device, data storage device, and all other types of devices and apparatuses.

Currently, there are many different types of cradle or stand devices on the market that allow and/or enable at least one type of cellular mobile phone, pager, Personal Digital Assistant, scanning device, reading device, camera device, music player device, video device, and other types of gadgets by they only provide the capability to (1) recharge power resources, or (2) transfer data and information capabilities primarily by wired means, but in some cases by wireless means from/thrulby/between—to another hardware device such as a desktop computer device, laptop device, or alike. But these capabilities stop here.

With the above stated invention, a user is now able to utilize any type of cradle or stand device to provide more functions, features, and services to at least one user than just power or data transfer capabilities.

Now a user can utilize a cradle or stand device as a primary hard drive or data storage device. A user then does NOT require any type of computer device (such as a desktop computing device, laptop, pad device or alike) to interact, interface, store, arrange, file, recall, modify, delete, or alike. A user can send any type of data and information to the cradle or stand device by wired and/or wireless means at any time, and from anywhere. A user does not have to acquire and save such data and information to say a mobile device, removable media device, or alike, then carry it with them back to physically input the data and information into the cradle or stand device to store and data.

An example of this is related to Cellular Mobile Phones, PDA's, or Pager devices. Say the user is running around a city area. They find some kind or type of data and information that they like, but it takes to long to download the data and information onto their hardware device, or removable media device, or the device does not have any or very little data hard drive capabilities inside of it, or it will use up to much of the persons hardware devices power resources to facilitate such a request. Now the user can simply have it sent to their cradle or stand device and keep going through life. The user can access this information at a later point in time by wired means, when they have time to do so, when they have access to another device that is wired to plentiful power resources, or a larger size hardware device such as a desktop, laptop, pad device, or other.

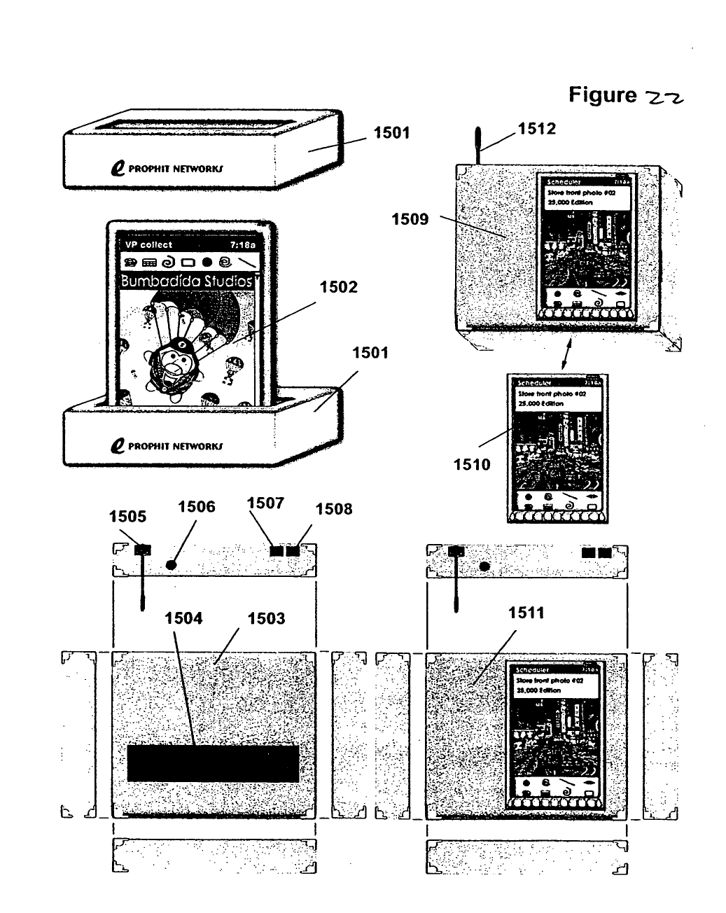

FIG. 22 the purpose is to show an alternative preferred embodiment of the present invention employed utilizing a modified version of finger held hardware device that employs modified versions of a viewable screen apparatus enabling the a viewable screen apparatus to be moved around horizontally by the user, and configured at various locations, angles, degrees, and alike constructed in accordance with the invention. At least one type of finger held hardware device could be designed that would allow a user to move, adjust, modify, arrange, change, or alike to various positions, angles, degrees, and alike from the far left of the finger held hardware device 1603, to the far right of the finger held hardware device 1604, or in the middle portion of the finger held hardware device 1602.

Flexibility in design, and configuration of at least one type of finger held hardware device will allow and enable the device to be more personalized by its user.

At least one type of physical button apparatus 1601 of at least one type of finger held hardware device design can also be flexible in design to allow the user of the device to move, replace, twist, turn, rotate, spin, push, pull, arrange, modify, change, the location of each physical button, or by changing and establishing a new set of command sets applied to each physical button when the user touches each button. This can come on the form of physical adjustments, by replacement of the entire physical button apparatus, by software applications that are available on the finger held hardware device, the screen portion, or on the replaced button apparatus, from a local and/or remote network, carrier, or provider, by removable media, by wired or wireless communications or connections, or other means.

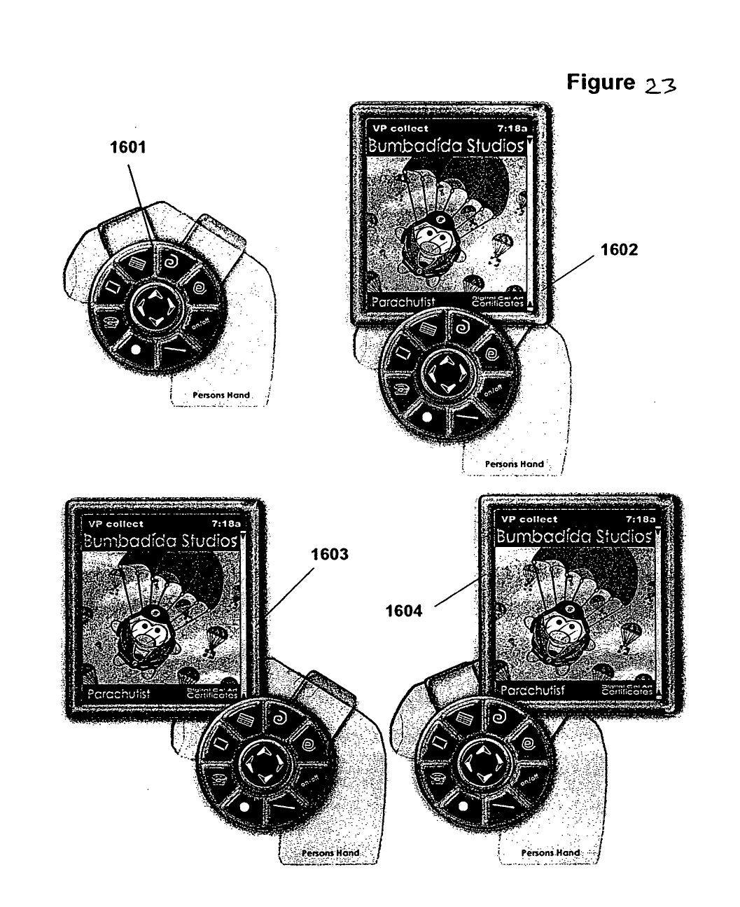

FIG. 23 the purpose is to show an alternative preferred embodiment of the present invention employed utilizing a modified version of finger held hardware device that employs modified versions of a viewable screen apparatus enabling the a viewable screen apparatus to be moved around vertically by the user, and configured at various locations, angles, degrees, and alike constructed in accordance with the invention. At least one type of finger held hardware device could be designed that would allow a user to move, adjust, modify, arrange, change, or alike to various positions, angles, degrees, and alike vertically up and down from the left side of the finger held hardware device 1701, or vertically up and down from the right side of the finger held hardware device 1702, or there locations, and configurations.

Flexibility in design, and configuration of at least one type of finger held hardware device will allow and enable the device to be more personalized by its user.

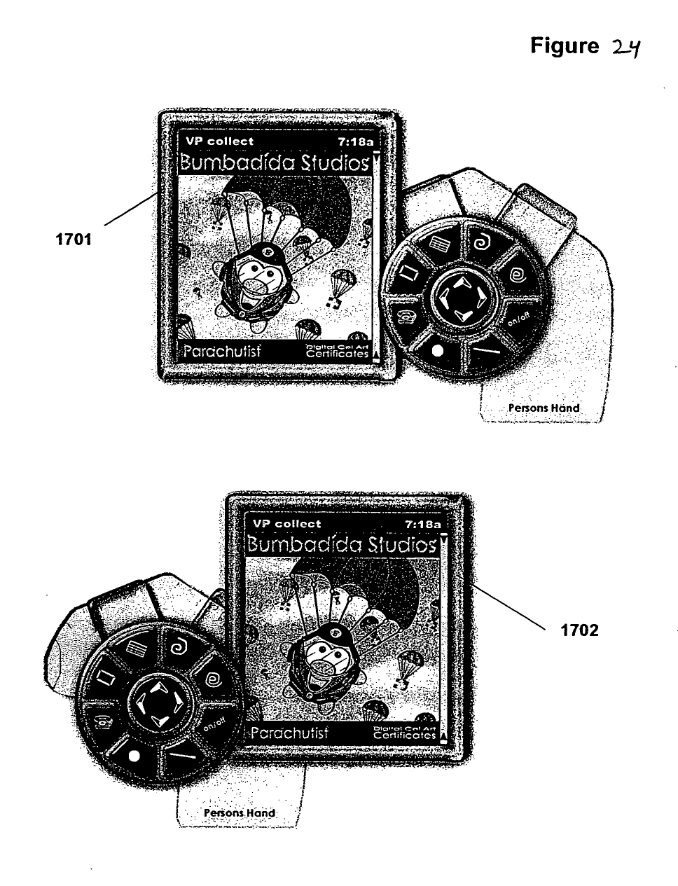

FIG. 24 the purpose is to show a general block diagram to the preferred embodiment of the present invention employed utilizing a cellular phone based finger held hardware device employing one particular design that enables any type of finger held device, with a fixed and/or removable display screen device and physical button device that can provide cellular phone, (PDA) personal digital assistant, paging, text messaging, camera, music player, game player, internet access, and other capabilities as part of or in addition to of the preferred embodiment of the present invention and alike constructed in accordance with the invention.

At least one type of cellular phone based finger held hardware device can utilize at least one type of display screen 1801 apparatus, or physical button 1802 apparatus, as part of a single unit design, or as part of a multiple, comprising of more than one, removable and interchangeable configuration. At least one type of single unit design, or multiple component or sectional unit can utilize any type of flexible design 1811 that would allow a user to move, adjust, rotate, twist, slide, modify, arrange, or alike to various positions, angles, degrees, or other configurations to the display, buttons, and other portions, or functions of any particular display, buttons, or other portions of the device.

At least one type of cellular phone based finger held hardware device could utilize at least one type of navigation or scrolling button 1803 configuration, at least one type of menu 1804 selection configuration, at least one type of physical cellular phone button 1805 configuration, at least one type of music player capabilities with menu 1804 selection, rewind 1806, fast forward 1810, play/pause/stop 1809, at least one type of microphone 1808, speaker 1812, power connector 1813, head phone plug in 1814, at least one type of On/Off, main and sub-category 1807 to day timers, calendar, things to do list, addresses, internet access, paging, text messaging, and other configurations to name a few, at least one type of connection point for a cradle or stand 1816, and at least one type of flexible or adjustable strap 1817, or material configuration enabling user to hold onto the device with at least one finger, or thumb.

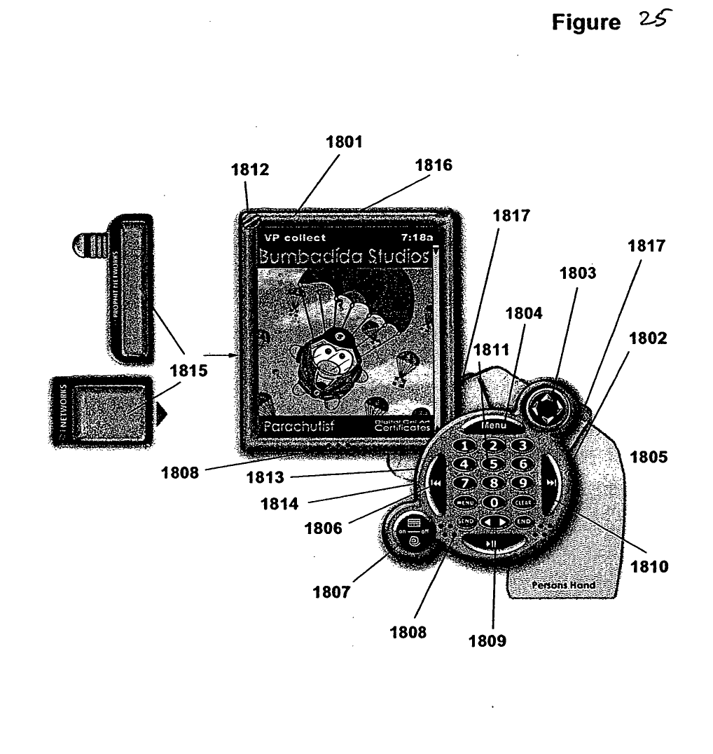

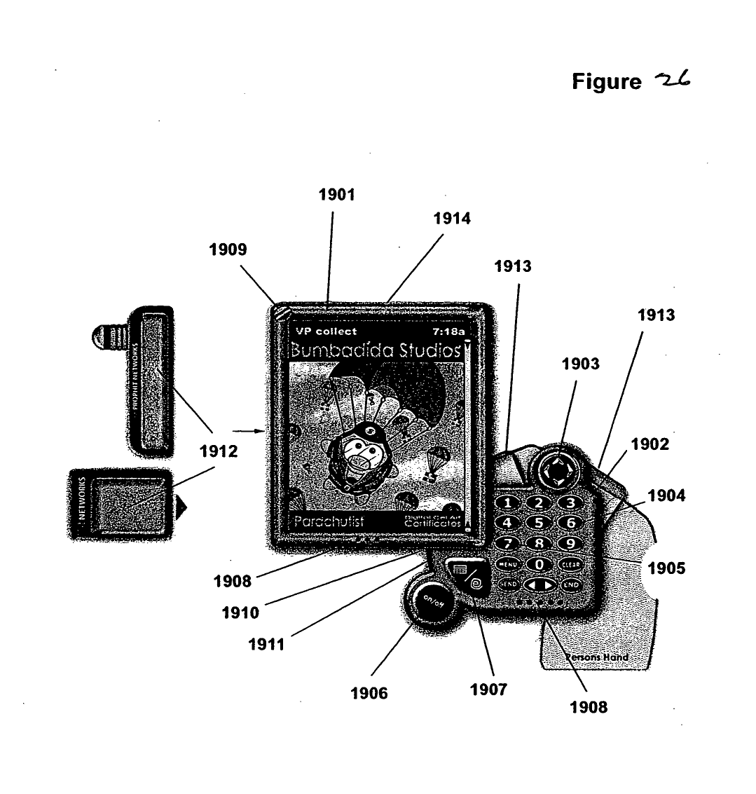

FIG. 25 the purpose is to show an alternative preferred embodiment of the present invention employed utilizing a modified version of finger held hardware device that employs modified versions of a cellular phone based finger held hardware device employing one particular design that enables any type of finger held device, with a fixed and/or removable display screen device and physical button device that can provide cellular phone, (PDA) personal digital assistant, paging, text messaging, camera, music player, game player, internet access, and other capabilities as part of or in addition to of the preferred embodiment of the present invention and alike constructed in accordance with the invention.

At least one type of cellular phone based finger held hardware device can utilize at least one type of display screen 1901 apparatus, or physical button 1902 apparatus, as part of a single unit design, or as part of a multiple, comprising of more than one, removable and interchangeable configuration. At least one type of single unit design, or multiple component or sectional unit can utilize any type of attachment in the design 1911 that would allow a user to attach the display screen portion to the physical button portion and operate in accordance to the design.

At least one type of cellular phone based finger held hardware device could utilize at least one type of navigation or scrolling button 1903 configuration, at least one type of microphone 1908 and speaker 1912, 9 at least one type of physical cellular phone button 1904 configuration, at least one type of On/Off button 1906, at least one type of main and sub-category 1907 selections to day timers, calendar, things to do list, addresses, internet access, paging, text messaging, and other configurations, at least one type of microphone 1908, speaker 1909, power connector 1910, head phone plug in 1911, at least one type of network capabilities, removable media, and games capabilities 1912, at least one type of connection point for a cradle or stand 1914, and at least one type of flexible or adjustable strap 1913, or material configuration enabling user to hold onto the device with at least one finger, or thumb.

At least one type of finger held hardware device, viewable screen area, and/or physical button device can be utilized in providing, inputting, sending, receiving, interacting, storing all types of content, communications with any and all content, data, and information from internal means and methods, and/or from external means, and/or methods. At least one type of finger held hardware device can be utilized as a cellular phone hardware device, a personal digital assistant device, pager, an electronic game, or game device, a music player or other player device, camera device, video device, radio device, tracking device, scanning device, reading device, remote control device, and interaction with home appliances, office equipment of all types and styles including desktop computers, laptops, printers, scanners, radio device, paging device, and all other forms, any types of combinations, types, styles, formats, and kinds of hardware devices. At least one type of finger held hardware device can be utilized to communicate and interact with anyone, anywhere, at any time, on a single, duel, and/or multiple frequency, spectrum, and/or at least one network service provider, or multiple network service providers on any wired, wireless, and/or combination platforms thereof.

Any and all functions, and features in whole and/or in part can be incorporated into any such designed finger held hardware device and/or any type of hardware device, portable terminal device, or computing device.

From the foregoing it will be appreciated by one skilled in the art that, although specific embodiments of the invention have been described herein for purposes of illustration, various modifications may be made without deviating from the spirit and scope of the invention. Accordingly, the invention is not limited except as by the appended claims.

1. A personal handheld electronics device, comprising:
at least one control logic system, the control logic system comprising a processor and a system memory;
a display coupled with the control logic system; and
a keypad unit, the keypad unit being coupled with the control logic system and further comprising:
an array of function control keys coupled with the control logic system;
a finger held base, the finger held base resting against at least one finger of a user's hand and supporting the function control keys, the finger held base extending outside a perimeter of the display so that applying pressure to the function control keys causes pressure to be exerted against the at least one finger of the user's hand to facilitate a grip on the device; and
a finger attachment device coupled with the finger held base, the finger attachment device extending from the finger held base and wrapping around the at least one finger of the user's hand to support the grip on the device.
